(19) United States
(12) Patent Application Publication
(10) Pub. No.: US 2011/0107108 A1
(43) Pub. Date: May 5, 2011

(54) CONTENT RECORDER/PLAYER AND CONTENT WRITING AND READING METHOD

(76) Inventor: Tatsuya HIRAI, Kanagawa (JP)

(21) Appl. No.: 12/642,462

(22) Filed: Dec. 18, 2009

(30) Foreign Application Priority Data
Dec. 18, 2008 (JP) 2008-322482

(51) Int. Cl. G06F 12/14

(52) U.S. Cl. 713/189

(57) ABSTRACT

A content recorder/player. The content recorder/player includes a first data-storage medium including a first data-storage area, a second data-storage medium including a second data-storage area, and a control section. The control section is configured: to encrypt information groups having a predetermined relationship for writing into the first data-storage area; to generate and to encrypt an individual information group from which the information having the predetermined relationship is omitted, and to perform writing thereof into the second data-storage area; to read and to decrypt the individual information group, and to read and to decrypt an information group recorded on a first recording-destination location; and to restore, from an information group read from the second data-storage area, and from an information group read from the first data-storage area, an information group correlated with the content data based on the predetermined relationship, and to transmit the restored information group to an external device.

### CROSS-REFERENCE TO RELATED APPLICATION

This application claims priority from the Japanese Patent Application No. 2008-322482, filed Dec. 18, 2008, the disclosure of which is incorporated herein in its entirety by reference.

### TECHNICAL FIELD

Embodiments of the present invention relate to a content recorder/player that stores therein content data and control information.

### BACKGROUND

For recording content data such as moving image data and music data into a data-storage medium or a storage device, as used herein a data-storage device, in view of copyright protection, means is often taken for storing, while encrypting the content data itself, information for use to perform usage control over the content data, such as: copy allowed frequency, and viewing/listening allowed period together with key data for encryption of contents. In this case, the means appropriate to prohibit reading of the key data without permission, or the means appropriate to prohibit tampering with the information about the usage control, may be provided. Especially, for recording such information on any optical data-storage medium, means for recording after encryption is known in the art.

Moreover, for recording data including a plurality of records onto a storage device, means for, by a host device, logically configuring a data storage section itself and a common data storage section, and means for, by the host device, appropriately selecting and designating a recording destination or a read-source area on a data-storage medium in accordance with the details of any included data are also known in the art.

Engineers and scientists engaged in content recorder/player manufacturing and development are interested in the design of content recorder/players that control the access to recording content data to meet the rising demands of the marketplace for increased content handling capability, performance, and reliability.

### SUMMARY

Embodiments of the present invention include a content recorder/player. The content recorder/player includes a first data-storage medium including a first data-storage area, a second data-storage medium including a second data-storage area, and a control section. The control section is configured: to encrypt, when any of a plurality of information groups each correlated with content data has a predetermined relationship with another in terms of a portion of information, the information groups, which are associated with base values, having the predetermined relationship for writing into the first data-storage area; to generate and to encrypt an individual information group from which the information having the predetermined relationship is omitted, and to perform writing thereof into the second data-storage area together with information about a recording-destination location to the first data-storage area; to read and to decrypt the individual information group and an information group as a result of the writing together with information about a recording-destination location to the first data-storage area, and from the information about the recording-destination location to the first data-storage area, to read and to decrypt an information group recorded on a first recording-destination location; and to restore, from an information group read from the second data-storage area, and from an information group read from the first data-storage area, an information group correlated with the content data based on the predetermined relationship, and to transmit the restored information group to an external device.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is an example block diagram showing the configuration of a data transfer system, in accordance with an embodiment of the present invention.

FIG. 2 is an example block diagram showing an example configuration of a storage device, in accordance with an embodiment of the present invention.

FIG. 3 is an example block diagram showing a modified example of the data transfer system, in accordance with an embodiment of the present invention.

FIG. 4 is an example table showing example contents in usage control information, in accordance with an embodiment of the present invention.

FIG. 5 is an example diagram showing an example authentication process to be executed before a transfer process of the usage control information, in accordance with an embodiment of the present invention.

FIG. 6 is an example diagram showing an example transfer process of the usage control information from a content recorder/player to a storage device for the purpose of writing, in accordance with an embodiment of the present invention.

FIG. 7 is an example diagram showing the configuration of a storage security manager in the storage device that implements the writing process of the usage control information in the first example, in accordance with an embodiment of the present invention.

FIG. 8 is an example flow chart showing the procedure of a writing process of the usage control information in the storage security manager in the first example, in accordance with an embodiment of the present invention.

FIG. 9 is an example diagram showing an example transfer process of the usage control information from the storage device to the content recorder/player for the purpose of reading, in accordance with an embodiment of the present invention.

FIG. 10 is an example diagram showing the configuration of a storage security manager in the storage device that implements the reading process of the usage control information in the first example, in accordance with an embodiment of the present invention.

FIG. 11 is an example flow chart showing the procedure of the reading process of the usage control information in the storage security manager in the first example, in accordance with an embodiment of the present invention.

FIG. 12 is an example diagram showing the configuration of a storage security manager in a storage device that implements a writing process of the usage control information in a second example, in accordance with an embodiment of the present invention.

FIG. 13 is an example flow chart showing the procedure of the writing process of the usage control information in the storage security manager in the second example, in accordance with an embodiment of the present invention.

FIG. 14 is an example diagram showing the configuration of the storage security manager in the storage device that implements the reading process of the usage control information in the second example, in accordance with an embodiment of the present invention.

FIG. 15 is an example flow chart showing the procedure of the reading process of the usage control information in the storage security manager in the second example, in accordance with an embodiment of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### Description of Embodiments of the Present Invention for a Content Recorder/Player and a Content Writing and Reading Method

With relevance to embodiments of the present invention, an issue has arisen, with the advance of technology, with respect to increasing, with an increase of the number of information portions for recording after encryption, the load of processing related to encryption/decryption and transfer thereof. The issue becomes more apparent with a higher and severer degree of encryption/decryption.

As is known in the art, when the storage device is a detachable type, the internal configuration thereof varies depending on the product type due to, for example, the advance of technology. Thus, this results in difficulties for the host device to manage the data-storage areas with methods known in the art while grasping the detailed internal configuration of each storage device, and to make available the storage device set with such an area management method for use by any other host devices, for example, to ensure interoperability.

Embodiments of the present invention are proposed in consideration of such circumstances, and provide a data transfer system, a data transfer method, a data transmission device, and a data reception device, all of which can reduce the load of processing related to encryption/decryption and transfer of information to be correlated to content data.

In accordance with embodiments of the present invention, a content recorder/player includes: data-storage media respectively including first and second data-storage areas; and a control section. In accordance with embodiments of the present invention, the control section is configured: to encrypt, when any of a plurality of information groups each correlated with content data has a predetermined relationship with another in terms of a portion of information, the information groups having the predetermined relationship for writing into the first data-storage area; to generate and to encrypt an individual information group from which the information having the predetermined relationship is omitted, and to perform writing thereof into the second data-storage area together with information about a recording-destination location to the first data-storage area; to read and to decrypt the individual information group and an information group as a result of the writing together with information about a recording-destination location to the first data-storage area, and from the information about the recording-destination location to the first data-storage area, to read and to decrypt an information group recorded on a first recording-destination location; and to restore, from an information group read from the second data-storage area, and from an information group read from the first data-storage area, an information group correlated with the content data based on the predetermined relationship, and to transmit the restored information group to an external device.

Alternatively, in accordance with embodiments of the present invention, the content recorder/player may include: a first data-storage medium for storage of content data; a second data-storage medium for storage of an information group correlated with the content data; and a control section configured to control of these data-storage media. In accordance with embodiments of the present invention, the control section is configured to record a second information group having a predetermined relationship with a first information group in terms of a portion of information; the control section is configured to write, onto an area on the second data-storage medium, together with information about a recording-destination location of any predetermined information in the first information group, an individual information group generated by omitting the information having the predetermined relationship, and to play back the second information group. Moreover, in accordance with embodiments of the present invention, the control section is configured: to read and decrypt the individual information group and the information group written together with the information about the recording-destination location; to read the information of the first information group having the predetermined relationship from the information about the recording-destination location; to restore the information group correlated with the content data from the information of the first information group and the individual information group; and, to make a response of the restored information group to an external device.

Thus, in accordance with embodiments of the present invention, generating an individual information group may reduce the amount of information so that the load of processing related to encryption/decryption and transfer of the information may be reduced.

### First Example

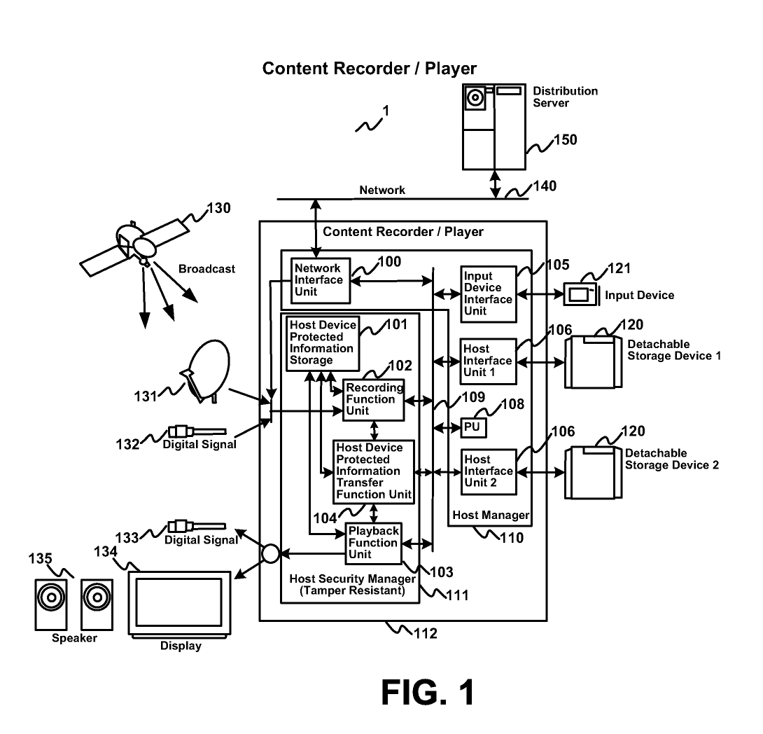

With reference now to FIG. 1, in accordance with an embodiment of the present invention, a block diagram is shown that shows the configuration of a data transfer system. The data transfer system 1 is configured to include a content recorder/player (Content Recorder/player) 112, and a plurality of detachable storage devices (Detachable Storage Device) 120 coupled thereto. The recorder/player 112 and the storage devices 120, as such, operate to transfer to each other content data, such as: moving image data and music data, and usage control information correlated to such content data, the details of which are subsequently described herein.

Also as described herein, a device on the data transmission end is defined as a first device; and, a device on the data reception end is defined as a second device. That is, when the recorder/player 112 transmits data, and when the storage device 120 receives the data, the recorder/player 112 corresponds to the first device, the data transmission device, and the storage device 120 corresponds to the second device, the data reception device. Conversely, when the storage device 120 transmits data, and when the recorder/player 112 receives the data, the storage device 120 corresponds to the first device, the data transmission device, and the recorder/player 112 corresponds to the second device, the data reception device.

The recorder/player 112 is mainly provided with a host manager (Host Manager) 110, and a host security manager (Host Security Manager) 111. These are coupled to each other over an internal bus 109.

The host manager 110 mainly has the capability of controlling data transfer among components coupled thereto. For example, components coupled to the host manager 110 generally include: a network interface unit (Network Interface Unit) 100 to be coupled to a network (Network) 140; an input device interface unit (Input Device Interface Unit) 105 for coupling with an input device (Input Device) 121; a plurality of host interface units (Host Interface Unit) 106 for respectively coupling with the storage devices 120; a processor unit (Processor Unit: PU) 108 for collectively managing the configuration components in the device in terms of operation; and, other components coupled to the host manager 110.

The host security manager 111 includes: a host device protected information storage (Host Device Protected Information Storage) 101, a recording function unit (Recording Function Unit) 102, a playback function unit (Playback Function Unit) 103, and a host device protected information transfer function unit (Host Device Protected Information Transfer Function Unit) 104. The detailed behavior of these as controlled by the processor unit 108 is subsequently described. The host security manager 111 may be partially or entirely configured by either hardware or software.

A broadcast wave transmission source 130 and a distribution server 150 serve to distribute content data after encrypting content data by a predetermined encryption scheme. The recorder/player 112 then acquires the content data provided by the broadcast wave transmission source 130, the distribution server 150, and other devices via: a broadcast wave reception antenna 131, a digital signal terminal 132, the network 140, and other means of reception. The content data is correlated with usage control information including key information for use to decrypt the encrypted content data; and, this usage control information is acquired by the recorder/player 112 together with the content data. This usage control information may be acquired from any distribution source from which content data is acquired, or alternatively, from any distribution source other than these.

The content data and the usage control information acquired as such are stored into the storage device 120 coupled to the recorder/player 112 by the operation of the recording function unit 102 and that of the host device protected information transfer function unit 104.

Moreover, the content data and the usage control information stored in the storage device 120 are decrypted and played back by the operation of the playback function unit 103 and that of the host device protected information transfer function unit 104. The content data played back as such is output to the digital signal terminal 133, a display 134, a speaker 135, and other output components.

The host security manager 111 is incorporated in the configuration with resistance against tampering. Such properties may prevent any unauthorized acquisition, copying, tampering, and other similar unpermitted activities with respect to information to be handled by the host security manager 111, for example, the usage control information, by general users. The outline of the processing details to be executed by various processing sections included in the host security manager 111 is as subsequently described. In addition to an authentication process with the storage device 120, the host device protected information transfer function unit 104 performs a transmission/reception process of the usage control information with the storage device based on the completed authentication process. In the authentication process, the processing, such as: verifying any provided certificate, and verifying information about any invalid certificate is generally performed; and ,the certificates and invalid information about any certificates are recorded in the host device protected information storage 101. The host device protected information storage 101 is also recorded as appropriate with any protection-required data such as progress log related to the authentication process, and the transfer process of the usage control information in the course of process execution.

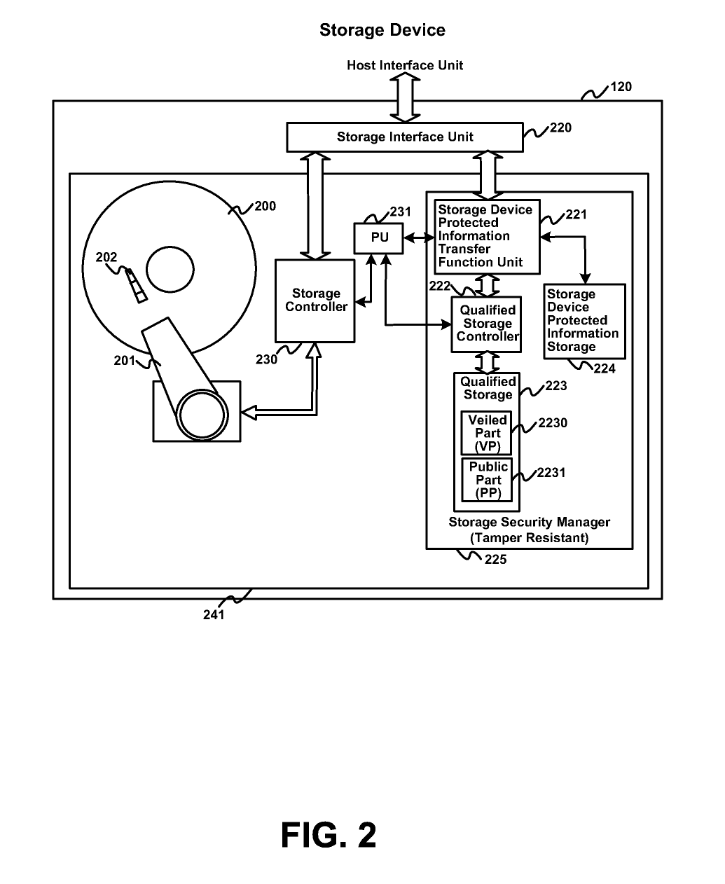

With reference now to FIG. 2, in accordance with an embodiment of the present invention, a block diagram is shown that shows an example configuration of the storage device 120. The storage device 120 is configured as a hard-disk drive (HDD) that performs data reading and writing in accordance with a request coming from the recorder/player 112. The storage device includes: a magnetic-recording disk 200, a magnetic-recording head 202 for data reading and writing, an arm 201 that supports the magnetic-recording head 202, a storage controller (Storage Controller) 230, and a processor unit (Processor Unit: PU) 231 that has control over those components, a storage interface unit (Storage Interface Unit) 220, and HDD components.

The magnetic-recording disk 200 is written with the content data provided by the recorder/player 112 after encryption. Note here that this magnetic-recording disk 200 is assumed as being able to perform data reading and writing therefrom/thereto with no limitation irrespective of what type of recorder/player.

Moreover, the storage device 120 includes, as the configuration corresponding to the host security manager 111, a storage security manager (Storage Security Manager) 225.

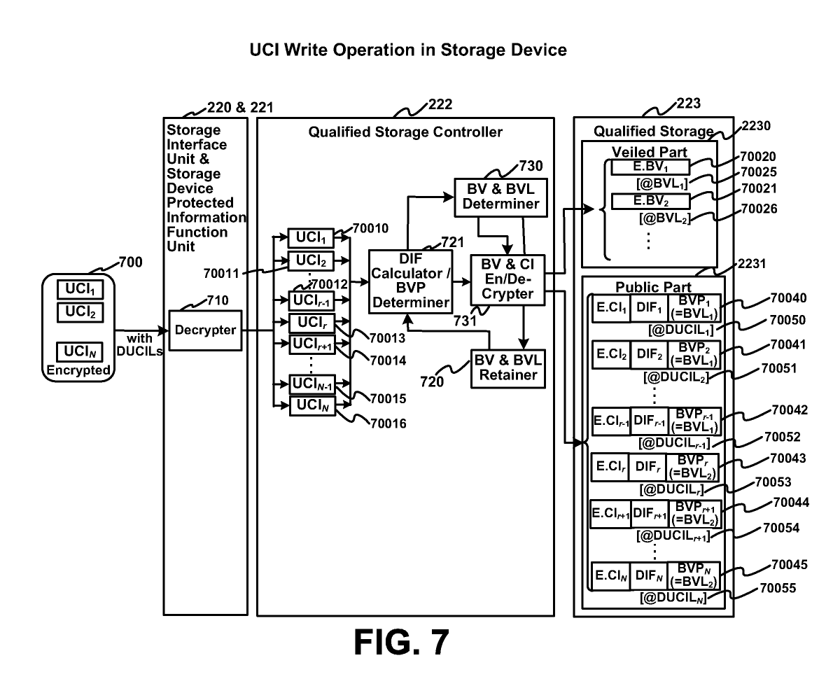

The storage security manager 225 includes: a storage device protected information transfer function unit (Storage Device Protected Information Transfer Function Unit) 221, a qualified storage controller (Qualified Storage Controller: QSC) 222, a qualified storage (Qualified Storage: QS) 223, and a storage device protected information storage (Storage Device Protected Information Storage) 224. The qualified storage 223 includes: a veiled part (Veiled Part: VP) 2230, and a public part (Public Part: PP) 2231. The description of how to use the veiled part 2230 and the public part 2231 is subsequently described in detail in the discussions of FIGS. 7, 8, 10 and 11. The storage security manager 225 is incorporated in the configuration with resistance against tampering similarly to the host security manager. The storage security manager 225 may be partially, or alternatively, entirely configured by either hardware, or alternatively, software.

The storage device protected information transfer function unit 221 and the storage device protected information storage 224 as such perform processing similarly to the host device protected information transfer function unit 104 and the host device protected information storage 101. Moreover, the qualified storage controller 222 performs processing of recording the usage control information to the qualified storage 223, and reading the usage control information from the qualified storage 223.

The storage device 120 is configured as a HDD by way of example without limitation thereto, as the storage device 120 may be configured as any other type of storage device, such as, a semiconductor memory device, as long as the storage device includes the storage security manager 225.

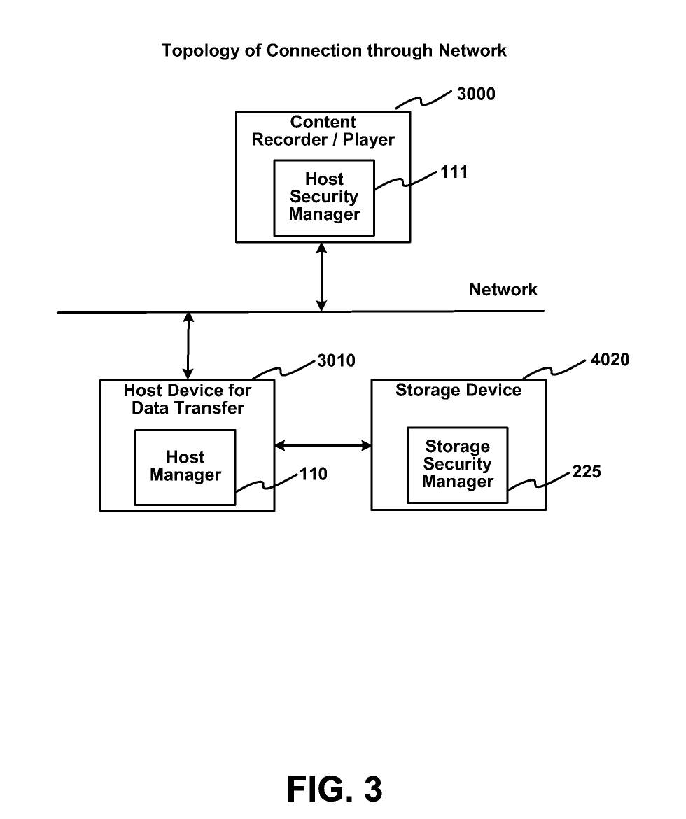

With reference now to FIG. 3, in accordance with an embodiment of the present invention, an example block diagram is shown that shows a modified example of the data transfer system. As described above, FIG. 1 shows the configuration in which the host security manager 111 and the storage security manager 225 are coupled proximally, but the coupling therebetween is not restrictive thereto. For example, the configuration of FIG. 3 is another suitable embodiment of the present invention. This configuration includes a content recorder/player 3000 including the host security manager 111, and a host device for data transfer (Host Device for Data Transfer) 3010 including only the host manager 110 serving as a data transmission/reception function, which are coupled to each other over the network. In the configuration, the host device for data transfer 3010 is coupled with a storage device (Storage Device) 4020 including the storage security manager 225. In this case, the data reading and writing process with respect to the storage device 120 is performed mainly by the host manager 110 of the host device for data transfer 3010; but, a process involving any direct access to the protected information, such as, for example, authentication and transfer of the usage control information, is executed by both the host security manager 111 of the content recorder/player 112, and the storage security manager 225 of the storage device 4020. The content recorder/player 3000 of FIG. 3 does not include the host manager 110 and the network interface unit 100; but, for communications with any other devices over the network, the content recorder/player 112 surely includes such function components. This is also applicable to the host device for data transfer 3010.

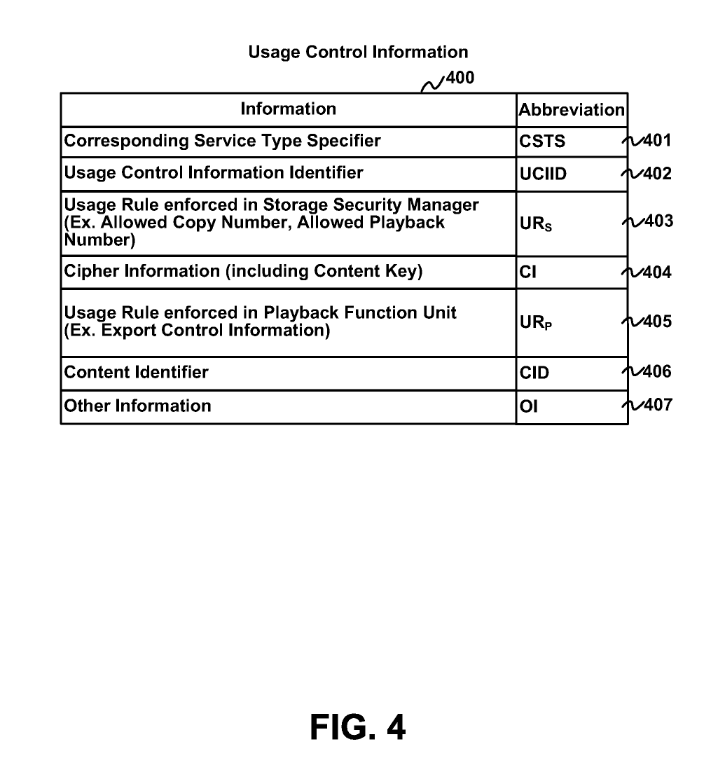

With reference now to FIG. 4, in accordance with an embodiment of the present invention, a table is shown that shows example contents in usage control information. As is next described in the discussion of FIG. 4, example usage control information may be transferred between the recorder/player 112 and the storage device 120.

The usage control information (Usage Control Information: UCI) is an information group including a plurality of types of information portions needed to control the usage of the content data, and is correlated with the content data.

A corresponding service type specifier (Corresponding Service Type Specifier: CSTS) 401 indicates to which service the content data correlated with the usage control information UCI belongs.

The usage control information identifier (Usage Control Information Identifier: UCIID) 402 is an identifier (ID) allocated to the usage control information UCI.

A usage rule enforced in storage security manager (Usage Rule Enforced in Storage Security Manager: UR_S) 403 indicates the rule on the end of the storage security manager 225 for limiting the use of the content data correlated with the usage control information UCI. The rule UR_S is exemplified, for example, by the allowed number of times for copying or viewing/listening. When a request comes from the content recorder/player 112 for use exceeding the requirements allowed by the rule, the storage security manager 225 does not output the usage control information UCI. Note here that x with an underline (e.g., _S) is written as a subscript in the drawing. This notation applies to all of the drawings subsequently referred to herein.

Cipher information (Cipher Information: CI) 404 is information including key data for decrypting the content data that is correlated to the usage control information UCI and that is in the state of being encrypted, and any parameters needed to perform computation related to encryption.

A usage rule enforced in playback function unit (Usage Rule enforced in Playback Function Unit: UR_P) 405 indicates the rule in the host security manager 111 for limiting the use of the content data correlated with the usage control information UCI. Such a rule is exemplified, for example, by information for specifying which device having been coupled thereto may perform output, and the allowed period of time for viewing/listening, but is not the same as the usage rule UR_S. When a user asks for the use exceeding the requirements allowed by this rule, the host security manager 111 does not decrypt the corresponding content data.

A content identifier (Content Identifier: CID) 406 is an identifier (ID) of the content data correlated to the usage control information UCI.

Other information (Other Information: OI) 407 is information having no direct relationship with the usage control over the content data.

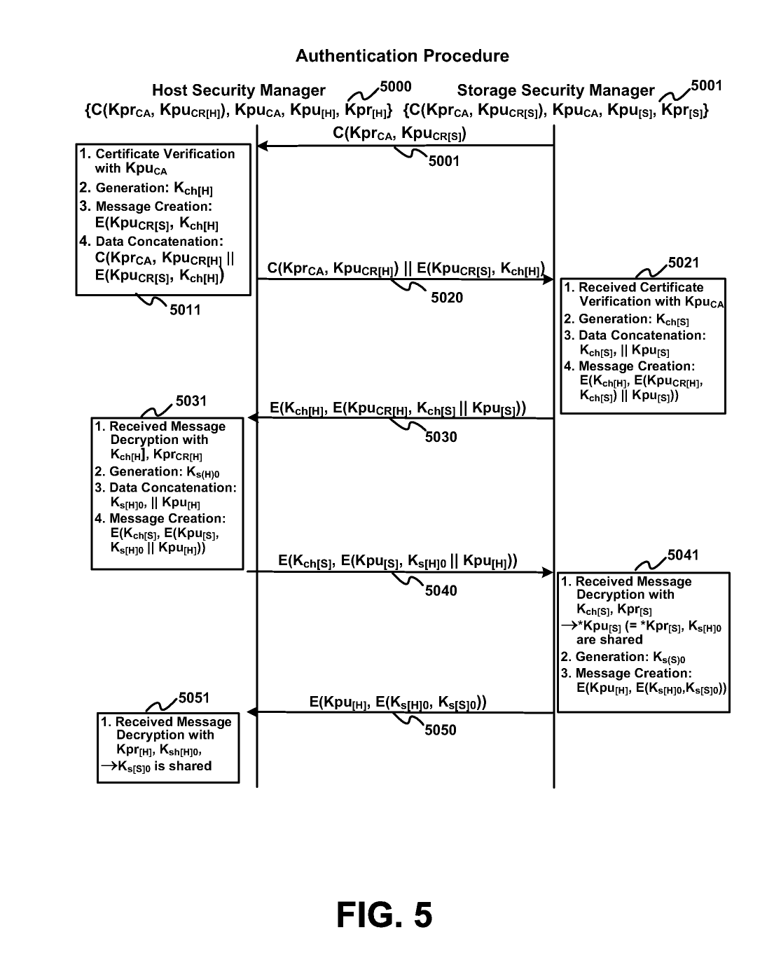

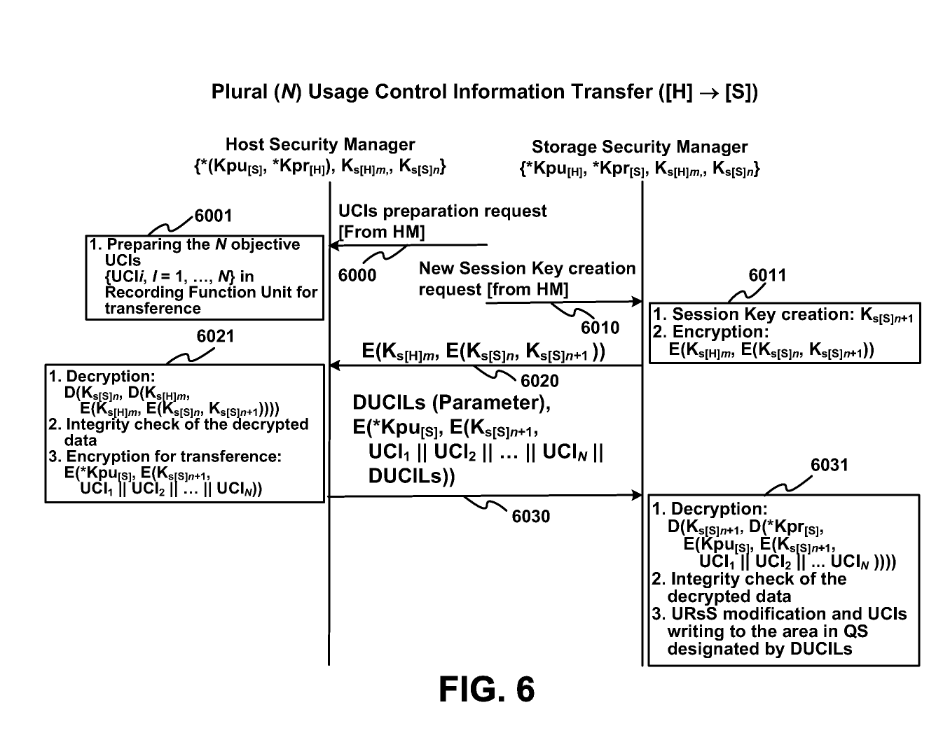

With reference now to FIGS. 5 and 6, in accordance with an embodiment of the present invention, a data transfer method is next described that is implemented between the recorder/player 112 and the storage device 120. FIG. 6 shows a transfer method for the usage control information; and, FIG. 5 shows an authentication process needed to be executed prior to the transfer.

### About Encryption

Before specifically describing the data transfer method of this embodiment, first of all, encryption for use in this embodiment is next described. In this embodiment, key data for asymmetric encryption and key data for symmetric encryption are used. Among these, two types of key data for asymmetric encryption use are, respectively, referred to as public key, and private key; and, the key data for symmetric encryption use is referred to as common key.

As is next described, the public key is expressed as Kpu_Exposition[Device], and the private key is expressed as Kpr_Exposition[Device]. Herein, the subscript x with [] as [x] is provided for distinguishing the base value (Base Value: BV) recorded on the veiled part VP 2230. For example, the bracketed letters [Device] each denote the device that keeps public key of the Device, or private key of the Device. When the letter in the square brackets is H, this denotes the recorder/player 112; and, when it is S, this denotes the storage device 120. Moreover, the subscripted character string of “Exposition” denotes the character string for illustrating the characteristics of the public key, or those of the private key. For example, Kpr_CA means: a private key kept track of and managed only by a certificate authority in charge of issuing certificates, which is generally used for calculating a digital signature found in any issued certificate. Kpu_CA is a public key with respect to the key Kpr_CA. These keys are used for verifying the digital signature found in the certificate. Similarly, Kpu_CR denotes a public key found in each of the certificates; and, Kpr_CR denotes a private key with respect to this key Kpu_CR. In view of the above, a certificate including the Kpu_CR[Device], and a digital signature section as a calculation result using the key Kpr_CA is referred to as C(Kpr_CA, Kpu_CR[Device]).

The common key is referred to as K_ch[Device], and K_s[Device]Order. Among these two common keys, the key K_ch is referred to as challenge key (Challenge Key), and the key K_s is referred to as session key (Session Key). The challenge key K_ch is a key that is generated on a temporarily basis in the course of certificate exchange. On the other hand, the session key K_s is used for encrypting the usage control information at the time of transfer thereof. The session key is generated for use every time the transfer process is executed to the usage control information; and, thus, the order thereof is represented as “Order”.

The process of encrypting data Y with a key data X is represented as E(X, Y). Similarly, the process of decrypting the data Y encrypted with the key data X is represented as D(X, Y). The process of finding a hash value of the data X is represented as H(X), and the process of coupling together the data X and the data Y is represented as X∥Y.

The computation method for asymmetric encryption is additionally described next. In this embodiment, in the course of the authentication process, encryption with the public key Kpu is executed for a plurality of times. For encryption with the public key Kpu, and for decryption with the private key Kpr with respect to the public key, a case is exemplified of sharing one specific key data in secret using the well-known Diffie-Hellman method (DH method), and subjecting any target message data to symmetric encryption with the key data, but this method is not restrictive. As another example, for example, any target message data may be directly encrypted with the public key Kpu; and, on the end of receiving the encrypted message data, the received data may be directly decrypted with the private key. Herein, the asymmetric encryption algorithm may not be restricted in type.

As an example, a key data sharing method by the original DH method based on the power computation, and a key data sharing method based on the addition computation on an elliptic curve are next described. In order to share the key data between the two based on the original DH method based on the power computation, first of all, between the two, a specific value G is shared in advance. For convenience of description, these two are referred to as device I and device II, respectively. Note here that the value G may be on public view. Thereafter, the device I generates a portion of natural number a of a predetermined length, and keeps it in secret. The device I then multiplies the value G of shared use by a, and forwards the resulting value G~a (where ~ denotes power) to the device II. Similarly to the device I, the device II generates a portion of natural number b, and keeps it in secret. After receiving the value G~a, the value G~a is multiplied again by b this time, and the result will be a value (G~a)~b. At the same time, the value G~b as a result of multiplying the value G by b is transmitted to the device I. Upon reception of the value G~b, the device I multiplies this value G~b by a again, thereby deriving a value (G~b)~a. By the process, as such, the value (G~b)~a=(G~a)~b is shared in secret by the devices I and II.

Assuming that a and b are the private keys Kpr1 and Kpr2 of the devices I and II, respectively, and assuming that the values G~a and G~b are the public keys Kpu1 and Kpu2 of the devices I and II, respectively, an encrypted value E(Kpu1, M) with the public key Kpu1 of specific message data M based on the DH method is the one derived actually by finding a value E(G~a)~b, M) using the value (G~a)~b as key data for symmetric encryption use, and by coupling the key Kpu2 to the resulting value E(G~a)~b, M) so that E((G~a)~b, M)∥Kpu2 is generated. Note that, in view of computation, the values a, b, G~a, and G~b may be dynamically generated every time, or alternatively, may be permanently recorded on each of the devices.

The key data sharing method based on the addition computation on an elliptic curve is almost the same as the key data sharing method based on the power computation. However, the following three points are different:

1. The value G is generally referred to as base point, and is two-dimensional coordinates (Gx, Gy).

2. The power computation G~a is the a-times additional computation of the base point on the elliptic curve, referred to as a*G.

3. Because the computation result of b*(a*G) is the two-dimensional coordinate value, the value b*(a*G) is subjected to predetermined computation so that one-dimensional scalar value is calculated, and the message data M is encrypted with this resulting one-dimensional scalar value being the key data for symmetric encryption use.

In this embodiment, the description of E(Kpu, M) is assumed as denoting, as described above, E((G~a)~b, M)∥Kpu2, or alternatively, E(f(b*(a*G)), M)∥Kpu2. Note here that f(b*(a*G)) denotes the computation of finding one scalar value from the value b*(a*G). On the other hand, the description of E(*Kpu, M) means to subject the message data M to symmetric encryption with *Kpu=(G~a)~b or f (b*(a*G)). Decryption of M′=E(Kpu, M) is described as D(Kpr, M′), which has the meaning: to perform, with symmetric encryption, the decryption computation D((G~b)~a, M), or alternatively, D(f(a*(b*G)), M′) with *Kpu=(G~b)~a or f(b*(a*G)).

With further reference to FIG. 5, in accordance with an embodiment of the present invention, a diagram is shown that shows an example authentication process to be executed prior to the transfer process of the usage control information. The host device protected information storage 101 in the host security manager 111 is assumed as is recorded in advance with: a certificate C(Kpr_CA, Kpu_CR[H]), a certificate authority public key Kpu_CA, a host device public key Kpu_[H], and a host device private key Kpr_[H] (process 5000). Similarly, the storage device protected information storage 224 in the storage security manager 225 is assumed as is recorded in advance with: a certificate C(Kpr_CA, Kpu_CR[S]), the certificate authority public key Kpu_CA, a storage device public key Kpu_[S], and a storage device private key Kpr_[H] (process 5001).

In a process 5010, the storage device protected information transfer function unit 221 in the storage security manager 225 transmits, to the host security manager 111, the certificate C(Kpr_CA, Kpu_CR[S]) recorded on the storage device protected information storage 224.

In a process 5011, the host security manager 111 executes the following process:

1. The host device protected information transfer function unit 104 verifies the correctness of the provided certificate C(Kpr_CA, Kpu_CR[S]).

2. After the correctness of the provided certificate is verified, the challenge key K_ch[H] is generated.

3. With the public key Kpu_CR[S] included in the provided certificate C(Kpr_CA, Kpu_CR[S]), the key K_ch[H] is encrypted, thereby generating the encrypted data E(Kpu_CR[S], K_ch[H]).

4. The resulting encrypted data is coupled with the certificate C(Kpr_CA, Kpu_CR[H]) recorded on its own.

In a process 5020, the host device protected information transfer function unit 104 transmits, to the storage security manager 225, thus derived data C(Kpr_CA, Kpu_CR[H])∥E(Kpu_CR[S], K_ch[H]).

In a process 5021, the storage security manager 225 executes the following process:

1. The storage device protected information transfer function unit 221 verifies the correctness of the provided data.

2. After the correctness of the provided data is verified, this data is decrypted with the public key Kpr_CR[S] recorded on its own so that the challenge key K_ch[H] is acquired.

3. After completion of acquisition of the challenge key K_ch[H], a challenge key K_ch[S] is generated, and the challenge key K_ch[S] is coupled with the public key Kpu_[S] recorded on its own.

4. The data as a result of the coupling in the process 5021.3 is encrypted with the public key Kpu_CR[H] found in the provided certificate of the host security manager 111, thereby generating the encrypted data E(Kpu_CR[H], K_ch[S]∥Kpu_[S]). Moreover, the resulting encrypted data E(Kpu_CR[H], Kch[S]∥Kpu_[S]) is encrypted with the provided key K_ch[H], thereby deriving the encrypted data E(K_ch[H], E(Kpu_CR[H], K_ch[S]∥Kpu_[S]).

In a process 5030, the storage device protected information transfer function unit 221 transmits, to the host security manager 111, the encrypted data derived in the process 5021.4.

In a process 5031, the host security manager 111 executes the following process:

1. The host device protected information transfer function unit 104 decrypts the provided encrypted data with the key K_ch[H] of its own, and the private key Kpr_CR[H].

2. A zero-order session key K_s[H]0 is generated.

3. The key K_s[H]0 is coupled with the public key Kpu_[H] recorded on its own.

4. After the data K_s[H]0∥Kpu_[H] is encrypted with the key K_pu[S] found in the result of data decryption, it is encrypted also by the key K_ch[S], thereby generating the encrypted data E(K_ch[S], E(Kpu_[S], K_s[H]0∥Kpu_[H])). As a result of this computation, in the host device protected information transfer function unit 104, a sharing key *Kpu_[S] is generated.

In a process 5040, the host device protected information transfer function unit 104 transmits, to the storage security manager 225, the encrypted data E(K_ch[S], E(Kpu_[S], K_s[H]0∥Kpu_[H])) derived in the process 5031.4.

In a process 5041, the storage security manager 225 executes the following process:

1. The storage device protected information transfer function unit 221 decrypts the provided encrypted data with the key K_ch[S] of its own, and the private key Kpr_[S]. As a result of this computation, in the storage device protected information transfer function unit 221, a sharing key *Kpr_[S] is generated. Herein, the sharing keys Kpu_[S] and Kpr_[S] are actually the same in value.

2. A zero-order session key K_s[S]0 is generated.

3. After the key K_s[S]0 is encrypted with the key K_s[H]0 found in the decryption result of the provided encrypted data, it is encrypted also by the key Kpu_[H], thereby generating the encrypted data E(Kpu_[H], E(K_s[H]0, K_s[S]0)). As a result of this computation, in the storage security manager, a sharing key *Kpu_[H] is generated.

In a process 5050, the storage device protected information transfer function unit 221 transmits, to the host security manager 111, the encrypted data E(Kpu_[H], E(K_s[H]0, K_s[S]0)) derived in the process 5041(3).

In a process 5051, the host security manager 111 executes the following process:

1. The host device protected information transfer function unit 104 decrypts the provided encrypted data with the private key Kpr_[H] of its own, and the zero-order session key K_s[H]0. As a result of this computation, in the host device protected information transfer function unit 104, the sharing key *Kpr_[S] is generated.

As described above, the process, such as, confirmation of data completeness at the time of decrypting the provided encrypted data, is not specifically described; but, such a process is assumed to be surely executed. Moreover, in the course of the authentication process, a process of transmitting, from a device of including the newer certificate invalid information, the newer certificate invalid information to another device, and overwriting the previous certificate invalid information, for example, may be additionally performed.

The process procedure described above is strictly no more than an example of the authentication process to be executed between the devices. However, after completion of the authentication process, the devices through this authentication process are sharing the key data for use to transfer the usage control information after encryption, and the key data sharing the key data for use at the time of the transferring. In the case of the example of FIG. 5, such key data includes: a host device sharing key *Kpu_[H] (=*Kpr_[H]), a storage device sharing key *Kpu_[S] (=*Kpr_[S]), a host device zero-order session key (K_s[H]0), and a storage device zero-order session key (K_s[S]0).

Writing Process of Usage Control Information from a Recorder/Player to a Storage Device

With further reference to FIG. 6, in accordance with an embodiment of the present invention, a diagram is shown that shows an example transfer process of the usage control information from the recorder/player 112 to the storage device 120. At the point in time when the transfer process is started, the host security manager 111 and the storage security manager 225 are assumed as sharing: the sharing key *Kpu_[S] (=*Kpr_[S]), a host device m-order session key (K_s[H]m), and a storage device n-order session key (K_s[S]n). This means that, before the execution of the transfer process, the usage control information from the recorder/player 112 to the storage device 120 is subjected to the transfer process for n times, and the usage control information from the storage device 120 to the recorder/player 112 is subjected to the transfer process for m times. Note here that, n and m may denote 0, so that only the authentication process may be executed.

In a process 6000, the host manager 110 makes a request to the host device protected information transfer function unit 104 and the recording function unit 102 in the host security manager 111 for making ready N portions of the usage control information UCI_1 to UCI_N for transmission to the storage device 120.

In a process 6001, the recording function unit 102 generates the N portions of the usage control information UCI_1 to UCI_N for transmission. The host device protected information transfer function unit 104 temporarily stores such usage control information UCI_1 to UCI_N.

In a process 6010, while the host security manager 111 is executing the process 6001, the host manager 110 transmits a session key data generation request to the storage device protected information transfer function unit 221 in the storage security manager 225.

In a process 6011, the storage security manager 225 executes the following process:

1. The storage device protected information transfer function unit 221 generates a session key K_s[S]n+1.

2. The storage device protected information transfer function unit 221 uses the keys K_s[S]n and K_s[H]m to encrypt the key K_s[S]n+1 generated in the process 6011.1. The keys K_s[S]n and K_s[H]m are both the latest among the session keys generated so far by the storage device protected information transfer function unit 221 and the host device protected information transfer function unit 104 shared thereby for use at the time of execution of this process.

In a process 6020, the storage device protected information transfer function unit 221 transmits, to the host manager 110, the generated encrypted data E(K_s[H]m, E(K_s[S]n, K_s[S]n+1)).

In a process 6021, the host security manager 111 executes the following process:

1. The host device protected information transfer function unit 104 decrypts, with the key K_s[H]m of its own and the key K_s[S]n, the provided encrypted data E(K_s[H]m, E(K_s[S]n, K_s[S]n+1)).

2. The host device protected information transfer function unit 104 checks the completeness of the decryption result of K_s[S]n+1. Such a completeness check process includes, for example, checking whether a tag value allocated to the session key K_s[S]n+1 is correct or not, or checking whether data is correct or not based on an error detection code assigned to the session key K_s[S]n+1.

3. The host device protected information transfer function unit 104 couples the N portions of the usage control information made ready in the process 6001 together with their destination locations for UCIs DUCILs (Destination Location for UCIs), respectively, thereby performing encryption using the decryption result of K_s[S]n+1 and the sharing key *Kpu_[S] of shared use in the authentication process. At this time, the host interface unit 106 may designate any information about the destination location as a parameter coming together with a write command separately from the message data for transmission. With the storage devices that are currently widely used, such as, HDDs, such means is considered effective in view of keeping track of the size of data to be received.

In a process 6030, the host device protected information transfer function unit 104 transmits, to the storage security manager 225, the generated encrypted data E(*Kpu_[S], E(K_s[S]n+1, UCI_1∥ . . . ∥UCI_∥DUCILs)).

In a process 6031, the storage security manager 225 executes the following process:

1. The storage device protected information transfer function unit 221 decrypts the provided encrypted data E(*Kpu_[S], E(K_s[S]n+1, UCI_1∥ . . . ∥UCI_N∥DUCILs)) with the sharing key *Kpr_[S] and the key K_s[S]n+1 of its own.

2. The storage device protected information transfer function unit 221 checks the completeness of the decryption result of UCI_1∥ . . . ∥UCI_N∥DUCILs.

3. After changing the usage rule enforced in storage security manager UR_S in accordance with the predetermined rule, the qualified storage controller 222 records the usage control information UCI_1 to UCI_N at the positions indicated by the rule DUCILs in the qualified storage 223. After completion of the recording as such, the usage control information UCI_1 to UCI_N is deleted from the qualified storage controller 222.

With such a process, the writing process of the usage control information UCI_1 to UCI_N into the qualified storage 223 is completed.

At this time, when N portions of content data respectively correlated with the N portions of the usage control information UCI_1 to UCI_N for transmission are collectively configuring a program, for example, among the information found in the usage control information UCI_1 to UCI_N (refer to FIG. 4), the corresponding service type specifier USTS, the usage rule enforced in storage security manager UR_S, and a playback function usage rule URP have no difference of UCI number in most cases. Moreover, the usage control information identifier UCIID and the content identifier CID are considered as often showing a change by any predetermined rule, for example, showing successive changes by a predetermined increment (1, for example).

The issue here is that, for implementation of a qualified storage, if any new data-storage medium is to be incorporated with physical means of some type to be able to prevent tampering and any unauthorized access separately from a data-storage medium that has been incorporated in a previous storage device, such incorporation often involves a lot of difficulties. Moreover, for implementing such prevention of tampering and unauthorized access, new development and incorporation of data-storage medium is provided, thereby possibly leading to a problem of increasing the development cost of the device itself In order to avoid such an issue, it is considered effective if the storage interface unit 220 or the storage device protected information transfer function unit 221 is provided with such a function as logically limiting any access from any coupled host device, and if the data-storage medium already provided therein is partially used as is. However, for recording of protection-required information into the qualified storage 223 in order to make invalid such an attack as directly reading the information recorded in the area in the device by disassembling the storage device, it is effective to take such measures, such as, performing encryption with key data kept track of only by the qualified storage controller 222.

For recording of data into the qualified storage 223 in accordance with such course of action described above, if data being a target for writing and reading is increased in amount, this results in a load increase of encryption/decryption process in the qualified storage controller 222, thereby causing a reduction in quality of the transfer process over the usage control information in the storage device.

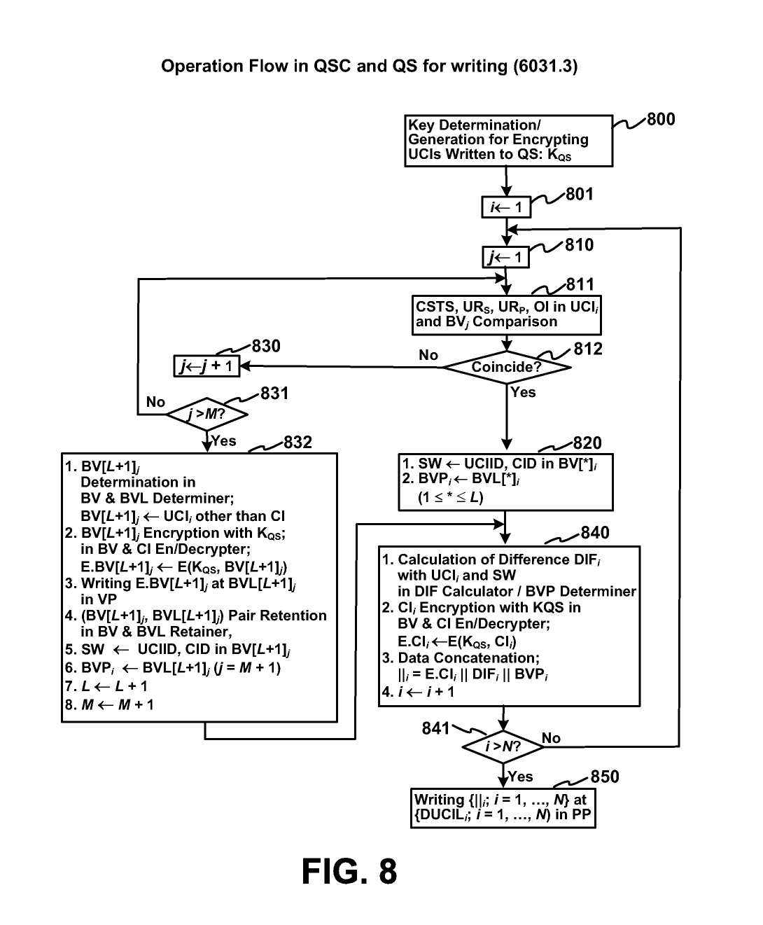

In consideration thereof, with reference now to FIGS. 7 and 8, in accordance with an embodiment of the present invention, a process of writing the usage control information into the qualified storage 223 with a higher efficiency in the process 6031.3 is next described. FIG. 7 shows the module configuration implementing this process procedure, and means for actually recording the provided N portions of usage control information.

### Components in Storage Security Manager for Usage Control Information Writing Process

In the next paragraph, a detailed description is also given of the roles of the components in the storage security manager together with a description of the detailed operation in the storage security manager in the usage control information writing process; but, a brief inspection of FIG. 7 also serves to summarize these descriptions.

The storage security manager carries therein, as components: a retainer of a base value (Base Value; BV) and a recorded location of the base value (Recorded Location of Base Value; BVL) (BV & BVL Retainer) 720, a determiner of a difference (Difference; referred to as DIF) calculator/BVP pointer (BV Pointer; BVP) (DIF Calculator/BVP Determiner) 721, a BV and BVL determiner 730 (BV & BVL Determiner), and a BV and CI encrypter/decrypter (BV & CI En/Decrypter) 731. The quality storage (QS) 223 is configured to include a veiled part (Veiled Part) (VP) 2230, and a public part (Public Part) (PP) 2231.

The BV & BVL retainer (BV & BVL Retainer) 720 is a data-storage medium for retaining the base value and the recorded location thereof, both of which are subsequently described. This data-storage medium is generally of a volatile type, but may be also of a nonvolatile type. Herein, if a memory of a nonvolatile type is used, there is a possibility that the capacity may be entirely consumed in the course of operation. If this is the case, it is considered effective and most popular to overwrite any data that is estimated as being not necessary in terms of processing. For example, in view of process execution, it is highly possible that the data recorded in the earliest days matches such a purpose. However, the data recorded in the earliest days is not surely restrictive. The DIF calculator/BVP determiner (DIF Calculator/BVP Determiner) 721 determines to calculate a difference between the usage control information identifier (UCIID) and the content identifier (CID) included in the base value, and the identifier included in the usage control information UCI being the current processing target; and, the DIF calculator/BVP determiner (DIF Calculator/BVP Determiner) 721 also determines a base value pointer (Base Value Pointer; referred to as BVP) indicating the base value (BV) being the base of the usage control information. The BV & BVL determiner (BV & BVL Determiner) 730 determines the base value (BV) from the provided usage control information (UCI), and determines the writing-destination location of the base value from any vacant area in the veiled part (Veiled Part) (VP) 2230 in the qualified storage 223. The BV & CI en/decrypter (BV & CI En/Decrypter) 731 encrypts and decrypts the base value (BV) and the cipher information (CI) 404 included in the usage control information.

The public part (PP) 2231 is an area for direct data writing or reading of any recorded data by the host interface unit 106 designating the information about the location after completion of the authentication process defined between the storage device protected information transfer function unit 221 and the host device protected transfer function unit 221. On the other hand, there is no need to specifically define a command and location information for directly accessing the veiled part (VP) 2230 from the outside of the storage interface unit 220; and, in this sense, it is an area kept private from the host device. Note that, however, by any defined predetermined process being performed in the storage device, to any area kept private as such from the host device, indirect data recording or reading of any recorded data is allowed. Herein, as subsequently described in greater detail, the storage capacity to be retained as the veiled part (VP) 2230 may be smaller than that of the public part (PP) 2231 in terms of the processing characteristics so that the veiled part (VP) 2230 may be configured on a data-storage medium physically different from that for the public part (PP) 2231. If this is the case, when the data-storage medium configured with the veiled part (VP) 2230 is physically resistant to tampering, the recording of information into any veiled part may be made in plain text.

### Operation in Storage Security Manager in Usage Control Information Writing Process

As described in the process 6031.1, the data including the N portions of encrypted usage control information 700 recorded in the storage interface unit 220 is first of all decrypted with the keys K_s[S]m and the *Kpr_[S] in a decrypter (Decrypter) 710 in the storage device protected information transfer function unit 221. By such a decryption process, the qualified storage controller 222 temporarily stores therein the N portions of usage control information of UCI_1 to UCI_N 70010, 70011, 70012, 70013, 70014, 70015, and 70016 in the plain text. As is next described, before describing the operation, the qualified storage manager is assumed as being in the following state:

1. Among the N portions of the usage control information, the following of have the same values even with different subscripts: the corresponding service type specifiers (CSTS) 401 of UCI_1 and UCI_2, to UCI_r−1, the usage rule enforced in storage security managers (UR_S) 403 thereof, the usage rule enforced in playback function units (UR_P) 405 thereof, and the other information (OI) 407 thereof.

2. The corresponding service type specifier (CSTS) 401 of UCI_r, the usage rule enforced in storage security manager (UR_S) 403 thereof, the usage rule enforced in playback function unit (UR_P) 405 thereof, and the other information (OI) 407 thereof are assumed as being partially or entirely different from those of UCI_r−1, for example. On the other hand, the following of have the same values even with different subscripts: the corresponding service type specifiers (CSTS) 401 of UCI_r and UCI_r+1 to UCI_N−1 and UCI_N, the usage rules enforced in storage security managers (UR_S) 403 thereof, the usage rules enforced in playback function units (UR_P) 405 thereof, and the other information (OI) 407 thereof.

3. The veiled part (VP) 2230 stores therein L portions of base values (BV[1] to BV[L]) after being encrypted. Herein, a portion of base value (BV) denotes actual data that includes values of every item not including the cipher information CI 404 actually found in a portion of usage control information (UCI).

4. The BV & BVL retainer (BV & BVL Retainer) 720 temporarily stores therein M portions of a pair of the base value (BV) and the recorded location BVL actually recorded with the base value (BV) in the veiled part (VP) 2230 ((BV_1, BVL_1) to (BV_M, BVL_M)). Herein, M may be 0. The subscripts are those for identifying the base value BV, the recorded location BVL thereof, and others temporarily stored in the qualified storage controller 222.

Note here that the expression of BV[*] is used when there is no specific need to consider, for the description, the order in the veiled part (VP) 2230 of the base value (BV), which occurs when any corresponding thing is recorded appropriately in any area in the veiled part (VP) 2230.

With further reference to FIG. 8, in accordance with an embodiment of the present invention, a flow chart is shown that shows the procedure of a writing process of the usage control information in the storage security manager in the first example. The process procedure in the qualified storage controller 222 is next described.

### Process 800

Before the decryption process, or synchronous parallel process, the BV & CI en/decrypter (BV & CI En/Decrypter) 731 in the qualified storage controller 222 determines the usage control information encryption key K_QS, so that the qualified storage controller 222 generates, or alternatively, selects any from those already generated. The key K_QS may continuously use the fixed data that has been embedded in advance at the time of device manufacturing, or may generate a new data in accordance with any appropriate rule for use. In either of these cases, the usage control information encryption key K_QS is key data for use to encrypt and decrypt any recording data (described in the previous paragraph 4) for recording of the usage control information into the qualified storage. Therefore, for reading the usage control information recorded in the qualified storage, the key K_QS that has been used to encrypt the usage control information is able to be discriminated. The key K_QS serves as the core to implement the qualified storage; but, no further description of the retention method is given herein, being outside the scope of embodiments of the present invention.

### Process 801

The DIF calculator/BVP determiner (DIF Calculator/BVP Determiner) 721 sets 1 to a subscript variable i for use to identify the provided N portions of the usage control information UCI.

### Process 810

The DIF calculator/BVP determiner (DIF Calculator/BVP Determiner) 721 sets 1 to a subscript variable j for use to identify the base value BV for comparison with the provided information UCI.

### Process 811

The DIF calculator/BVP determiner (DIF Calculator/BVP Determiner) 721 reads the base value BV_j stored in the BV & BVL retainer (BV & BVL Retainer) 720 (herein j=1), and the base value recorded location BVL[*]_j configuring a pair with the base value BV[*]_j. The base value BV[*]_j (j=1) is then compared with the corresponding service type specifier (CSTS) 401 of the provided usage control information UCI_i (i=1), the usage rule enforced in storage security manager (UR_S) 403 thereof, the usage rule enforced in playback function unit (UR_P) 405 thereof, and the other information (OI) 407 thereof.

### Process 812

As a result of the comparison made in the process 811, when a matching is derived between the base value BV[*]_j (j=1) and the usage control information UCI_i (i=1) for every compared item, a process 820 is to be executed. When the items are not entirely showing such a matching, a process 830 is to be executed. First, the process procedure starting from the process 820 is next described; and, then, the process starting from the process 830 is described.

### Process 820

1. A variable for subtracting value (Variable for Subtracting Value; SVV) is set with the value of the usage control information identifier (UCIID) 402 included in the value BV[*]_j (j=1), and that of the content identifier (CID) 406 included therein. The variable for subtracting value is a variable under the management of the DIF calculator/BVP determiner (DIF Calculator/BVP Determiner) 721 for temporarily storing the value of the usage control information identifier (UCIID) 402 included in one base value BV, and that of the content identifier (CID) 406 included therein.

2. The base value pointer (BVP_i), which is used by the usage control information UCI_i, the details of which are subsequently described, is set with the base value recorded location BVL[*]_j (j=1) being a pair with the base value BV_j (j=1).

### Process 830

The value of the subscript j is added with 1.

### Process 831

A determination is made whether the value of j derived in the process 830 is larger or not than the total number M of the base value BV stored in the BV & BVL retainer (BV & BVL Retainer) 720 at this point in time. When the value of j is equal to or smaller than M, the procedure returns to the process 811. On the other hand, when the value of j exceeds M, for example, j=M+1, a process 832 is to be executed.

### Process 832

1. The DIF calculator/BVP Determiner (DIF Calculator/BVP Determiner) 721 transmits the provided usage control information UCI_i to the BV & BVL determiner (BV & BVL Determiner) 730. The determiner 730 generates the base value (BV) from the data other than the CI found in the provided usage control information UCI_i, and determines the recorded location BVL of the base value (BV). Generally, any area not used in the veiled part (VP) 2230 is selected for the recorded location BVL of the base value (BV). The base value BV and the recorded location BVL of the base value are then transmitted to the BV & CI en/decrypter (BV & CI En/Decrypter) 731, and the BV & BVL retainer (BV & BVL Retainer) 720. The subscript of the base value (BV) and that of the recorded location BVL of the base value are apparently BV[L+1]_j, and BVL[L+1]_j (where, j=M+1), respectively. Therefore, in subsequent discussion, such an expression is used.

2. The BV & CI en/decrypter (BV & CI En/Decrypter) 731 encrypts the provided L+1st base value BV[L+1] with the usage control information encryption key K_QS, thereby deriving the encrypted L+1st base value E.BV[L+1].

3. The BV & CI en/decrypter (BV & CI En/Decrypter) 731 writes the L+1st base value E.BV[L+1] as a result of the encryption by the process 832.2 into the area in the veiled part (VP) 2230 indicated by the provided base value recorded location BVL[L+1].

4. At the same time as the process 832.2 and the process 832.3, the BV & BVL retainer (BV & BVL Retainer) 720 newly stores the provided L+1st base value BV[L+1] and the recorded location of this base value BVL[L+1] as a pair of BV[L+1]_(M+1), BVL[L+1_(M+1)). Moreover, the pair of data stored as such is transmitted to the DIF calculator/BVP determiner (DIF Calculator/BVP Determiner) 721.

5. The DIF calculator/BVP determiner (DIF Calculator/BVP Determiner) 721 sets, to the variable for subtracting value SVV, the value of the usage control information identifier (UCIID) 402 and that of the content identifier (CID) 406 found in the provided BV[L+1]_(M+1).

6. The DIF calculator/BVP determiner (DIF Calculator/BVP Determiner) 721 sets, to the base value pointer BVP_i, the base value recorded location BVL[L+1]_(M+1) being a pair with the value BV_(M+1).

7. 1 is added to the base value and the number L of the base value BV recorded in the veiled part (VP) under the control of the BV & CI en/decrypter (BV & CI En/Decrypter) 731.

8. The BV & BVL retainer (BV & BVL Retainer) 720, and the DIF calculator/BVP determiner (DIF Calculator/BVP Determiner) 721 each add 1 to the total value M of the base value in the temporary storage. This addition process may be executed only by the BV & BVL retainer (BV & BVL Retainer) 720; and, the result may be transmitted to the DIF calculator/BVP determiner (BV Calculator/BVP Determiner) 721.

### Process 840

1. From the usage control information identifier (UCIID) 402 and the content identifier (CID) 406 of the usage control information UCI_i currently being the processing target, the DIF calculator/BVP determiner (DIF Calculator/BVP Determiner) 721 subtracts the value of the identifier found in the variable for subtracting value SVV determined in the process 820.1 or the process 832.5, thereby finding the difference DIF_i. Thereafter, the DIF calculator/BVP determiner (DIF Calculator/BVP Determiner) 721 transmits, to the BV & CI en/decrypter (BV & CI En/Decrypter) 731: the difference DIF_i, the cipher information (CI_i) 404 included in the usage control information UCI_i, and the base value pointer BVP determined in the process 820.2 or the process 832.6.

2. The BV & CI en/decrypter (BV & CI En/Decrypter) 731 encrypts the provided cipher information (CI_i) 404 with the usage control information encryption key K_QS, thereby deriving the encrypted cipher information CI_i.

3. The BV & CI en/decrypter (BV & CI En/Decrypter) 731 couples the encrypted cipher information E.CI_i as a result of the process 840.2 with the provided remaining two data, thereby storing the individual information group (Individual Information) II_i=E.CI_i∥DIF_∥BVP_i.

4. 1 is added to the subscript variable i for use to identify the N portions of the usage control information UCI.

### Process 841

The value of i as a result of the process 840.4 is compared with N.

### Process 850

As a result of the comparison in process 841, when the value of i is equal to or smaller than N, the usage control information UCI_i is subjected to the process 810 and onwards. On the other hand, when the value of i exceeds N, for example, i=N+1, the N portions of the individual information groups II_i as a result of the process 841.3 is written into an area in the public part PP (2231) indicated by the N portions of the destination locations DUCILs received by the storage interface unit 220.

In accordance with the process procedure as such, through division into the rule value that may share the content data among the information groups with a specific relationship and the individual information group, and through writing of the individual information group with the writing position of the rule value to allow the shared use of the portion of the rule value, the encryption process may be omitted for the rule value available for shared use so that, compared with the case of recording after complete encryption, the total amount of processing when the usage control information is recorded after encryption with the usage control information encryption key K_QS may be reduced to a considerable degree.

The process described above is no more than an example. For example, the writing of the individual information group II_i in the process 840.4 may be performed individually every time the value of i is determined. The function block configuration in the qualified storage controller 222 is also no more than an example. The configuration may be different therefrom, as long as the processes of FIG. 8 may be executed appropriately.

FIG. 7 shows an example of the configuration (result of recording) in which several encrypted base values, encrypted cipher information, differences, and base value pointers are recorded in the veiled part (VP) 2230 and the public part (PP) 2231. In FIG. 7, the encrypted cipher information E.CI_1 and E.CI_2 to E.CI_(r−1) and the differences DIF_1 and DIF_2 to DIF_(r−1) recorded at the destination locations for the usage control information DUCIL_1 (70050) and DUCIL_2 (70051) to DUCIL_(r−1) (70052) are each provided with the base value pointer BVP whose value is BVL_1 (70025) (70040, 70041, and 70042). With such a configuration, the encrypted cipher information E.CI_1 and E.CI_2 to E.CI_(r−1) and the differences DIF_1 and DIF_2 to DIF_(r−1) are coupled together with the value E.BV_1 (70020) recorded in the veiled part VP (2230), thereby configuring the original usage control information UCI_1 and UCI_2 to UCI_(r−1). On the other hand, the encrypted cipher information E.CI_r and E.CI_(r+1) to E.CI_N and the differences DIF_r and DIF_(r+1) to DIF_N recorded at the destination locations for the usage control information DUCIL_r (70053) and DUCIL_(r+1) (70054) to DUCIL_N (70055) are each provided with the base value pointer BVP whose value is BVL_2 (70026) (70043, 70044, and 70045). With such a configuration, the encrypted cipher information E.CI_r and E.CI_(r+1) to E.CI_N and the differences DIF_r and DIF_(r+1) to DIF_N are coupled together with the value E.BV_2 (70021) recorded in the veiled part (VP) 2230, thereby configuring the original usage control information UCI_r and UCI_(r+1) to UCI_N.

Reading Process of Usage Control Information from Storage Device to Recorder/Player

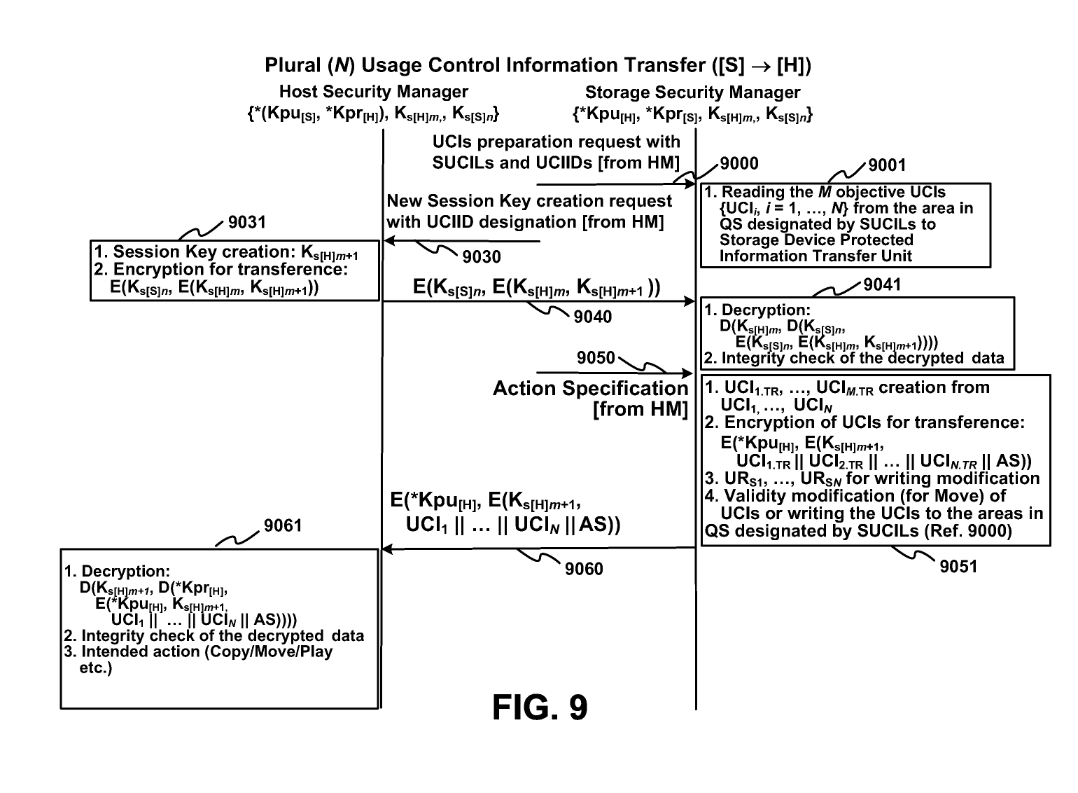

With reference now to FIG. 9, in accordance with an embodiment of the present invention, a diagram is shown that shows an example transfer process of the usage control information from the storage device 120 to the recorder/player 112. Similarly to the case of FIG. 6, the host security manager 111 and the storage security manager 225 are sharing: the key *Kpu_[S] (=*Kpr_[S]), the host device m-order session key (K_s[H]m), and the storage device n-order session key (K_s[S]n).

In a process 9000, the host manager 110 reads, from the qualified storage 223 to the storage device protected information transfer function unit 221, the N portions of the usage control information UCI_1 to UCI_N for transmission to the recorder/player 112, thereby making a request for the storage device protected information transfer function unit 221 to be ready for the transfer process.

At this time, the host manager 110 transmits the source location for UCIs SUCILs (Source Location for UCIs) on the qualified storage 223 storing the N portions of the usage control information UCI_1 to UCI_N to be transmitted, and the usage control information identifier UCIID for use to specify such usage control information UCI_1 to UCI_N. The usage control information identifier UCIID is not necessarily designated. For example, when the storage device 120 is a HDD including an advanced technology attachment (ATA) interface, and when the usage control information UCI_1 to UCI_N being the read target is recorded in any successive areas in the qualified storage 223, it is effective to notify, as one parameter for transmission to the storage device 120 together with a read command, the location where the first usage control information UCI_1 is recorded and the number N of the usage control information for reading.

In a process 9001, the qualified storage controller 222 executes the following process:

1. The usage control information UCI_1 to UCI_N is read from the qualified storage 223, and is temporarily stored. Herein, the qualified storage controller 222 serves also as a temporary storage section that temporarily stores the usage control information UCI_1 to UCI_N to be transferred.

2. The qualified storage controller 222 determines the usage control information status UCISs (UCIs Status) for the usage control information UCI_1 to UCI_N temporarily stored in the process 9001.1.

In a process 9030, while making the storage security manager 225 execute the process 9001, the host manager 110 transmits a session key data generation request to the host device protected information transfer function unit 104. At this time, if the first identifier UCIID_1, which is the one included in the usage control information UCI_1, among the usage control information for reading is transmitted in advance, it is effective to check whether the usage control information to be received later is the correct one or not.

In a process 9031, the host device protected information transfer function unit 104 executes the following process:

1. A session key K_s[H]m+1 is generated.

2. Thus generated session key K_s[H]m+1 is encrypted with the keys K_s[H] and K_s[S]n. The keys K_s[H] and K_s[S]n are both the latest among the session keys generated so far by the host device protected information transfer function unit 104 and the storage device protected information transfer function unit 221 shared thereby for use at the time of execution of this process.

In a process 9040, the host device protected information transfer function unit 104 transmits, to the storage security manager 225, the generated encrypted data E(K_s[S]n, E(K_s[H]m, K_s[H]m+1)).

In a process 9041, the storage device protected information transfer function unit 221 executes the following process:

1. With the keys K_s[S]n and K_s[H]m of its own, the provided encrypted data E(K_s[S]n, E(K_s[H]m, K_s[H]m+1)) is decrypted.

2. The completeness of the key K_s[H]m+1 derived in the process 9041.1 is checked.

In a process 9050, the host manager 110 notifies the storage device 120 of the application of reading the usage control information UCI_1 to UCI_N. The application here is exemplified by: decryption and play (Play) of the content data in the playback function unit 103 in the recorder/player 112, copy (Copy) or move (Move) of the usage control information UCI to any other storage device, and other operations.

In a process 9051, the storage device protected information transfer function unit 221 executes the following process:

1. The qualified storage controller 222 generates, from the N portions of the usage control information UCI_1 to UCI_N prepared in 9001, usage control information UCI_1.TR to UCI_N.TR for transfer use to actually transfer to the recorder/player 112. This process is executed, after copying the usage control information UCI_1 to UCI_N in the qualified storage controller 222, by changing the usage rule enforced in storage security manager UR_S included in the usage control information UCI_1.TR to UCI_N.TR in accordance with the command received in the process 9050.

2. The qualified storage controller 222 transmits, to the storage device protected information transfer function unit 221, the usage control information UCI_1.TR to UCI_N.TR generated in the process 9051.1 for transfer use. The storage device protected information transfer function unit 221 couples an action specifier (Action Specifier) (AS) for specifying the command provided in the process 9050 to the usage control information UCI_1.TR to UCI_N.TR provided for transfer use, and encrypts the resulting UCI_1.TR∥ . . . ∥UCI_N.TR∥AS with the key K_s[H]m+1 derived in the process 9041.2 and the sharing key *Kpu_[H] shared for use in the authentication process.

3. The qualified storage controller 222 changes, in accordance with the command received in the process 9050, the usage rule enforced in storage security manager UR_S 303 (UR_S1 to UR_SN) of the usage control information UCI_1 to UCI_N of its own.

4. The qualified storage controller 222 writes back the N portions of the usage control information UCI_1 to UCI_N in which the usage rule enforced in storage security manager UR_S 303 is changed in the process 9051.3 into an area in the qualified storage 223 in which the usage control information indicated by the source location for UCIs SUCIL_1 to SUCIL_N has been originally recorded. At this time, the usage control information UCI_1 to UCI_N stored by the qualified storage controller 222 may remain in storage without being made invalid. Herein, when the command provided in the process 9050 is for moving (Move), the qualified storage controller 222 makes invalid the usage control information on the qualified storage 223 indicated by the source location for UCIs SUCIL_1 to SUCIL_N, and the usage control information stored in the qualified usage controller 222, before outputting the usage control information for transfer use from the storage device protected information transfer function unit 221.

In a process 9060, the storage device protected information transfer function unit 221 transmits, to the host security manager 111, the encrypted data E(*Kpu_[H], E(K_s[H]m+1, UCI_1.TR∥ . . . ∥UCI_1.TR∥AS)) generated in the process 9051.2.

In a process 9061, the host device protected information transfer function unit 104 executes the following process:

1. The provided encrypted data E(*Kpu_[H], E(K_s[H]m+1, UCI_1.TR∥ . . . ∥UCI_1.TR∥AS)) is decrypted with the keys *Kpr_[H] and K_s[H]m+1 of its own.

2. The completeness of the resulting data UCI_1.TR∥ to ∥UCI_1.TR∥AS is checked.

3. The playback function unit 103 executes the predetermined process in accordance with the action specifier AS.

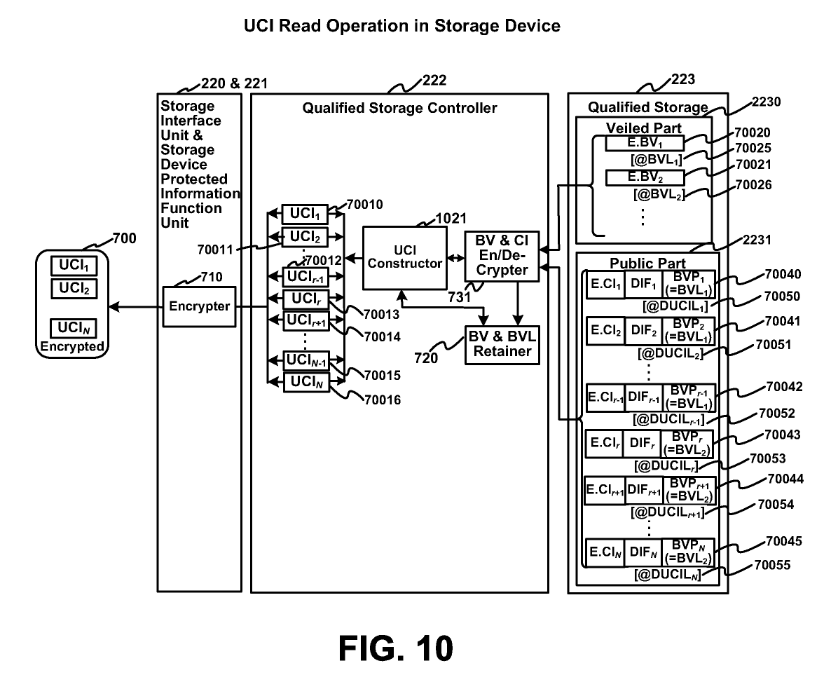

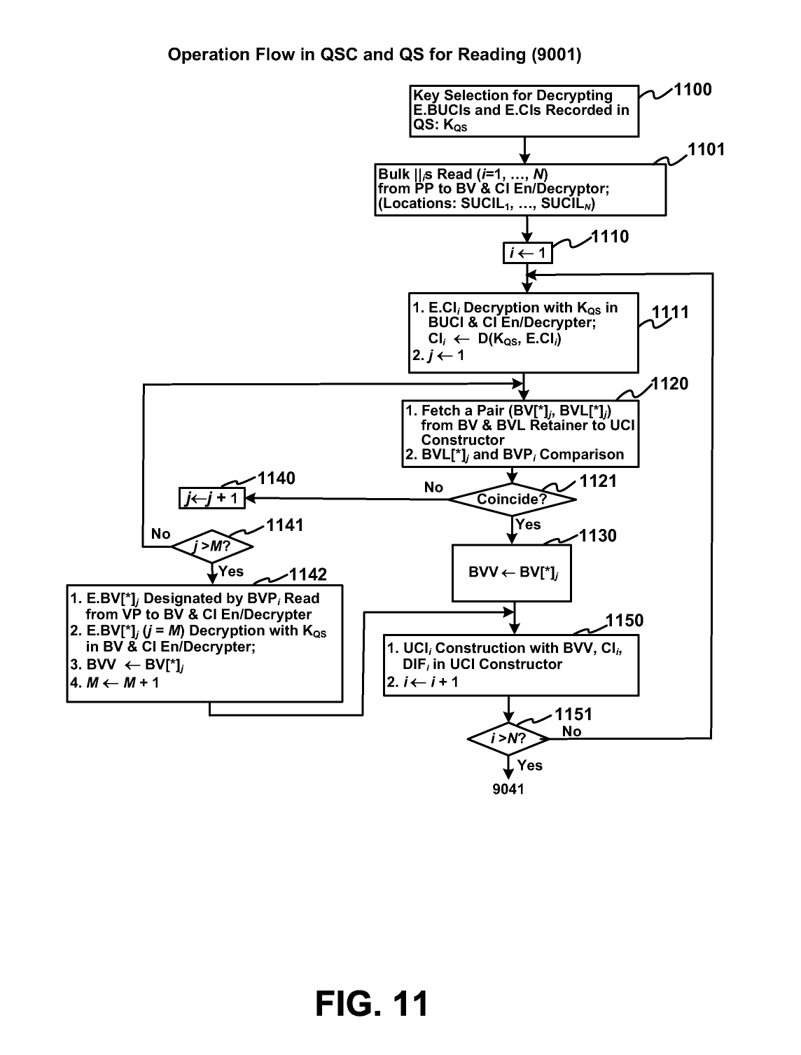

The process 9001 is subsequently described in detail is the process of reading the usage control information recorded in the qualified storage 223 by the qualified storage controller 222 by referring to FIGS. 10 and 11. The process of reading the usage control information recorded in the qualified storage 223 by the qualified storage controller 222 is the process, for the qualified storage controller 222 and the qualified storage 223, reverse to the writing process 6031.3 for the usage control information described by referring to FIGS. 7 and 8.

With reference now to FIG. 10, in accordance with an embodiment of the present invention, a diagram is shown that shows the module configuration implementing the procedure of this process, and means to be taken until the recorded N portion of usage control information is actually output from the storage device protected information transfer function unit 221.

### Components in Storage Device Security Manager for Usage Control Information Reading Process

A detailed description will be also given of the roles of the components in the storage security manager together with a description of the detailed operation in the storage security manager in the usage control information reading process; but, a brief inspection of FIG. 10 also serves to summarize these descriptions.

For execution of the usage control information reading process, the storage security manager is required to include an UCI constructor (UCI Constructor) 1021 as a component in addition to the BV & BVL retainer (BV & BVL Retainer) 720 and the BV & CI en/decrypter (BV & CI En/Decrypter) 731 used at the time of the reading process.

### Operation in Storage Security Manager in Usage Control Information Reading Process

Also, for the usage control information reading process, the notational conventions, such as, the subscript used in the writing process are used as previously described for the writing process. The reading process in the storage security manager is subsequently described in detail. However, at the point in time when this reading process is executed, similarly to the writing process, the BV & BVL retainer (BV & BVL Retainer) 720 is assumed as temporarily storing the M portions, which are the base value and the recorded location of the base value, of pairs ((BV_1, BVL_1) to (BV_M, BVL_M).

With reference also now to FIG. 11, in accordance with an embodiment of the present invention, a flow chart is shown that shows the procedure of the reading process of the usage control information in the storage security manager in the first example. The process procedure in the qualified storage controller 222 is next described.

### Process 1100

Before the decryption process, or synchronous parallel process, the BV & CI en/decrypter 731 (BV & CI En/Decrypter) in the qualified storage controller 222 determines the usage control information encryption key K_QS, such that, when a plurality of keys K_Q are in use, the qualified storage controller 222 selects any from the plurality of keys K_Q as appropriate.

### Process 1101

From the area in the public part (PP) 2231 indicated by the N portions of the recorded source location for UCIs SUCIL_1 to SUCIL_N received by the storage interface unit 220, the N portions of the individual information groups D_1 to D_N are collectively read into the BV & CI en/decrypter (BV & BVL En/Decrypter) 731. This reading process may be performed one each, or a few each. Herein, for purposes of description, for actually writing data onto a recording medium, or for reading the data from the recording medium, any existing storage device is assumed to be often executing any target process with a certain amount of data at a time.

### Process 1110

1. In the UCI constructor (UCI Constructor) 1021, 1 is set to a subscript variable i for use to identify the N portions of coupled data D being the read result.

### Process 1111

1. The BV & CI en/decrypter (BV & CI En/Decrypter) 731 decrypts the encrypted cipher information E.CI_i found in the read individual information group II_i, thereby deriving the cipher information CI_i.

2. In the UCI constructor (UCI Constructor) 1021, 1 is set to a subscript variable j for use to identify the base value BV and the recorded location BVL of the base value to be read from the BV & BVL retainer (BV & BVL Retainer) 720.

### Process 1120

1. The UCI constructor (UCI Constructor) 1021 reads the base value BV_[*]_j (j=1 in this example) stored in the BV & BVL retainer (BV & BVL Retainer) 720, and the base value recorded location BVL[*]_j configuring a pair with the base value BVL_j.

2. In a process 1101, the base value pointer BVP_i found in the individual information group II_i being the read result from the public part PP (2231) is compared with the base value recorded location BVL[*]_j being the result in the process 1120(1).

### Process 1121

As a result of the comparison in the process 1120.2, when a match is found between the two values, the process 1120 is to be executed. When no match is found therebetween, a process 1140 is to be executed. First, the procedure starting from the process 1130 is next described; and, then, the process starting from 1140 is described.

### Process 1130

The variable for BV (Variable for BV) (BVV) is set with the value of the base value BV[*]_j configuring a pair with the base value recorded location BVL[*]_j being the matching result in the process 1121.

### Process 1140

1 is added to the value of the subscript j.

### Process 1141

A determination is made whether the value of j as a result of the process 1140 is larger or not than the base value, and the total number M of the base value BV stored in the BV & BVL retainer (BV & BVL Retainer) 720 at this point in time. When the value of j is equal to or smaller than M, the procedure returns to the process 1120. On the other hand, when the value of j is exceeding M, for example, j=M+1, a process 1142 is to be executed.

### Process 1142

1. The UCI constructor (UCI Constructor) 1021 issues a command to newly read the encrypted base value E.BV[*]_j from the area in the veiled part (VP) 2230 indicated by the base value recorded location BVP_i to the BV & CI en/decrypter (BV & En/Decrypter) 731.

2. The BV & CI en/decrypter (BV & CI En/Decrypter) 731 decrypts the encrypted base value E.BV[*]_j read in the process 1142.1 with the usage control information encryption key K_QS selected in the process 1100, thereby deriving the base value BV[*]_j.

3. The base value BV[*]_j as a result of the process 1142.2 is set to the base value variable BVV.

4. The BV & BVL retainer (BV & BVL Retainer) 720 and the UCI constructor (UCI Constructor) 1021 each add 1 to the total number M of the base value that is temporarily in storage. Herein, this addition process may be executed only by the BV & BVL retainer (BV & BVL Retainer) 720, and the result may be forwarded to the UCI constructor (UCI Constructor) 1021.

### Process 1150

1. The UCI constructor (UCI Constructor) 1021 constructs again the normal usage control information from the base value variable BVV, the cipher information CI_i as a result of the process 1111.1, and the difference value of the identifier. For the usage control information identifier (UCIID) 402, and for the content identifier (CID) 406, for example, a difference value is added to the value of the usage control information identifier UCIID included in the base value variable BVV, and that of the content identifier CID included therein, thereby deriving the correct values. Moreover, the values included in the two types of usage rules 403 and 405, and the value included in the base value are assigned as they are. To the cipher information, the result of the process 1111.1 is assigned.

2. 1 is added to the value of the subscript i.

### Process 1151

The value of i as a result of the process 1150.2 is compared with N.

### Process 1150

As a result of the comparison in the process 1151, when the value of i is equal to or smaller than N, the procedure repeats the process 1111 and proceeds onwards. On the other hand, when the value of i exceeds N, for example, i=N+1, the transmission process 9041 is executed over the usage control information constructed with respect to the host device protected information transfer function unit 104.

The configuration in the qualified storage 223 of FIG. 10, which is the state in which the encrypted base values, the cipher information, the differences, the base value pointers, and others are recorded, is the same as that of FIG. 7.

By referring to FIG. 2 and other figures, an example is described that includes, in any same data-storage medium, the area for use as the veiled part (VP) 2230, and the area for use as the public part (PP) 2231; but, alternatively, these areas may be provided on any data-storage medium of a different type having different characteristics from the data-storage medium of FIG. 2. To be specific, the capacity to be provided as the veiled part (VP) 2230 for recording of the base value BV is generally considerably smaller in comparison with the capacity of the public part (PP) 2231 for recording of the base value BV. Accordingly, the public part (PP) 2231 is logically configured on a magnetic-recording disk; and, at the same time, a data-storage medium, such as, a semiconductor memory having access characteristics different from those of the magnetic-recording disk may be incorporated in the storage device, although a semiconductor memory is more costly; and, thus, the veiled part (VP) 2230 may be provided on the data-storage medium. With such a configuration, for writing and reading of the base value BV, the latency for head seeking and rotation of the magnetic-recording disk may be eliminated. Thus, the write and read time may be reduced to a greater extent than with a magnetic-recording disk, alone.

### Second Example

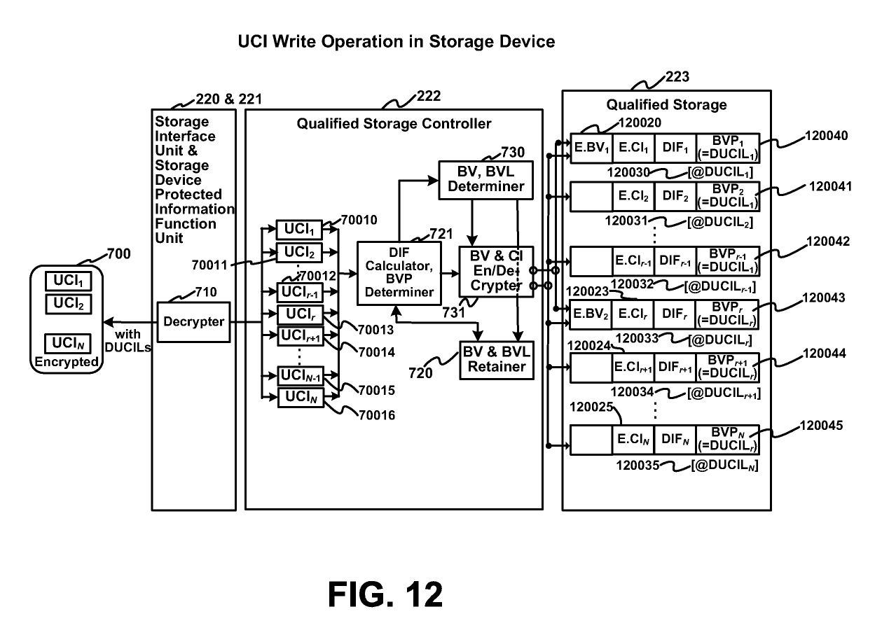

With reference now to FIGS. 12, 13, 14 and 15, in accordance with embodiments of the present invention, a second example is next described in which another implementation means is applied that is related to the usage control information writing process 6031.3, which is the operation inside of the storage security manager in the usage control information writing process, of FIG. 6, and the usage control information reading process 9001.1 corresponding thereto, which is the operation inside of the storage security manager of the usage control information.

### Components in Storage Security Manager for Usage Control Information Writing Process

With further reference to FIG. 12, in accordance with an embodiment of the present invention, a diagram is shown that shows the configuration of the storage security manager to be described in this second example; and, as is evident from the diagram, this is the same in many respects as the diagram of FIG. 7 of the first example. The difference lies in that the qualified storage 223 is not configured by a plurality of portions having each different characteristics in terms of access limitation such as the veiled part and the public part; rather, every portion has the characteristics of the public part.

### Operation in Storage Security Manager in Usage Control Information Writing Process

Also, in this second example, the four assumptions made in the first example still apply.

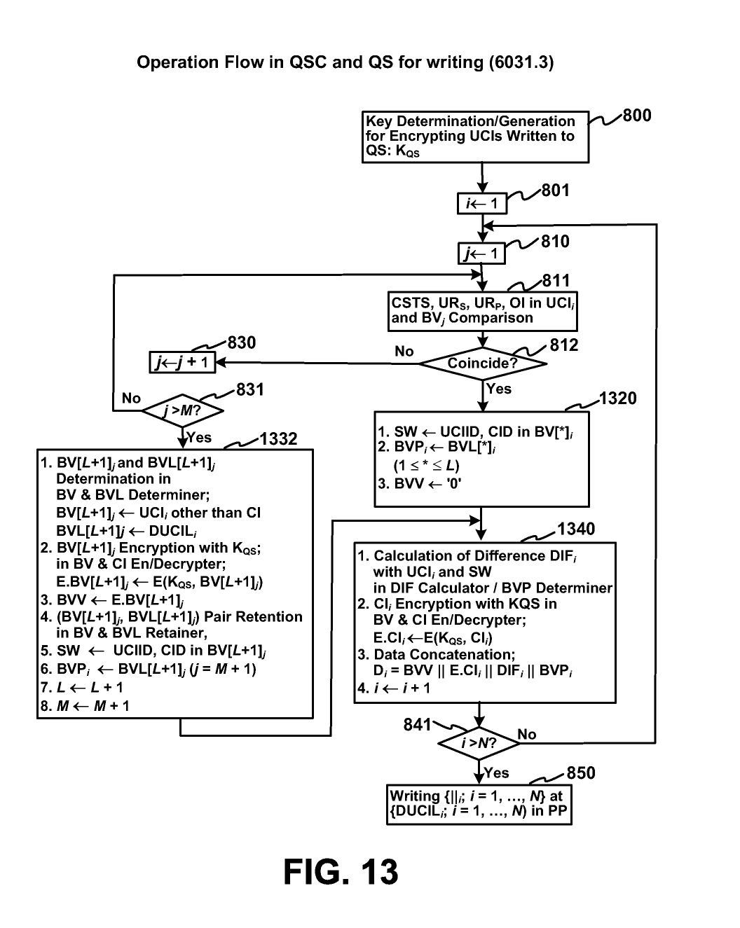

With further reference to FIG. 13, in accordance with an embodiment of the present invention, a flow chart is shown that shows the procedure of the writing process of the usage control information in the storage security manager in the second example. The writing process of the usage control information to the qualified storage is based on assumptions that are the same in many respects as the assumptions applicable to the process procedure of FIG. 8; but, there are several differences resulting from the fact that the qualified storage is different in configuration. Described below are mainly the differences.

### Process 1320

1. This is the same as the process 820.1.

2. This is the same as the process 820.2.

3. The variable for BV (Variable for BV) (BVV) is set with an arbitrary null value such as 0. The variable for BV (Variable for BV) (BVV) is a variable under the management of the DIF calculator/BVP determiner (DIF Calculator/BVP Determiner) 721.

### Process 1332

1. Similarly to the process 832.1, from the data included in the provided usage control information UCI_i but not CI, the base value BV is generated, and the recorded location BVL of the base value BV is determined. As to the recorded location BVL of the base value, the provided destination location for the usage control information DUCIL_i is set.

2. This is the same as the process 832.2.

3. The base value variable BVV is set with the encrypted base value E.BV[L+1]_j being the result of the process 1332.2. The base value variable is a variable under the management of the DIF calculator/BVP determiner (DIF Calculator/BVP Determiner) 721.

4. This is the same as the process 832.4.

5. This is the same as the process 832.5.

6. This is the same as the process 832.6.

7. This is the same as the process 832.7.

8. This is the same as the process 832.8.

### Process 1340

1. This is the same as the process 840.1.

2. This is the same as the process 840.2.

3. The BV & CI en/decrypter (BV & CI En/Decrypter) 731 couples the base value variable BV set in the process 1320.3, or in the process 1332.3, and the encrypted cipher information E.CI_i as a result of the process 1340.2 together with the provided remaining two data, thereby storing the individual information group II_i=BVV∥E.CI_i∥DIF_i∥BVP_i.

4. This is the same as the process 840.4.

Also when the usage control information writing process is executed in accordance with such a process procedure, the total processing load for recording the usage control information after encryption thereof with the usage control information encryption key K_QS in the storage device may be considerably reduced.

FIG. 12 shows an example configuration in which several encrypted base values, the encrypted cipher information, the difference, and the base value pointer are recorded in the qualified storage 223. In the drawing of FIG. 12, the encrypted cipher information E.CI_1 and E.CI_2 to E.CI_(r−1) and the differences DIF_1 and DIF_2 to DIF_(r−1) recorded at the destination locations for the usage control information DUCIL_1 (120030) and DUCIL_2 (120031) to DUCIL_(r−1) (120032) are each provided with the base value pointer BVP whose value is DUCIL_1 (120040, 120041, and 120042). With such a configuration of FIG. 12, the encrypted cipher information E.CI_1 and E.CI_2 to E.CI_(r−1) and the differences DIF_1 and DIF_2 to DIF_(r−1) are coupled together with the base value BV_1 (120020), thereby configuring the original usage control information UCI_1 and UCI_2 to UCI_(r−1). On the other hand, the encrypted cipher information E.CI_r and E.CI_(r+1) to E.CI_N and the differences DIF_r and DIF_(r+1) to DIF_N recorded at the destination locations for the usage control information DUCIL_r (120033) and DUCIL_(r+1) (120034) to DUCIL_N (120035) are each provided with the base value pointer BVP, whose value is BVL_2 (120023) (120043, 120044, and 120045). With such a configuration, the encrypted cipher information E.CI_r and E.CI_(r+1) to E.CI_N and the differences DIF_r and DIF_(r+1) to DIF_N are coupled together with the base value BV_2 (120023), thereby configuring the original usage control information UCI_r and UCI_(r+1) to UCI_N.

### Components in Storage Security Manager for Usage Control Information Reading Process

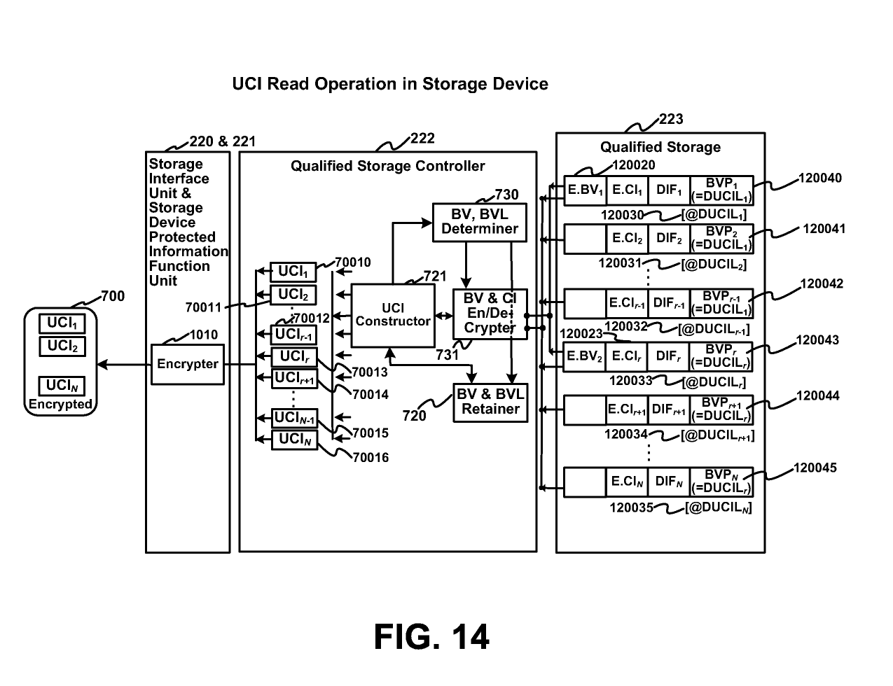

With further reference to FIG. 14, in accordance with an embodiment of the present invention, a diagram is shown that shows the configuration of the storage security manager in the storage device that implements the reading process of the usage control information in the second example. Similar to FIG. 12, this is the same as that of FIG. 10 in the first example except that the qualified storage 223 is not configured by a plurality of portions each having a different characteristic in terms of access limitation such as the veiled part and the public part; but, every portion has the characteristics of the public part.

Usage Control Information Reading Process from Storage Device to Recorder/Player

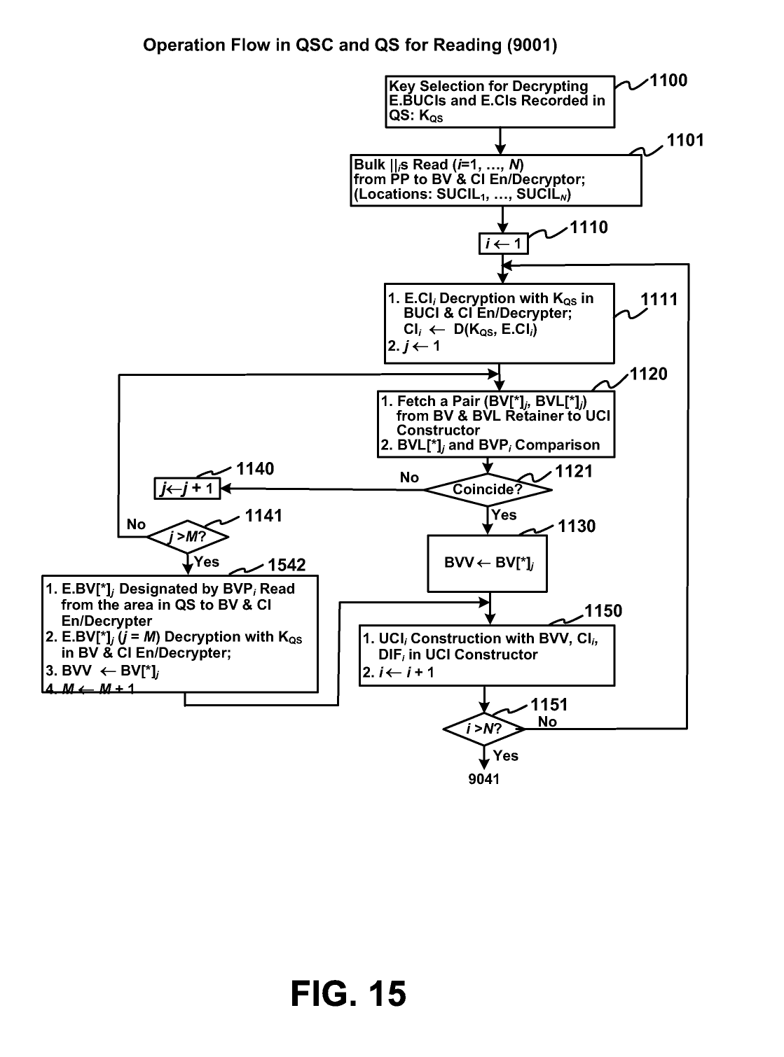

With further reference to FIG. 15, in accordance with an embodiment of the present invention, a flow chart is shown that shows the procedure of the reading process of the usage control information in the storage security manager in the second example. The process of reading the usage control information from the qualified storage in this example is the same in many respects as the process procedure in the first example of FIG. 11; but, there is a difference resulting from the fact that the destination of recording the base value (BV) is the qualified storage. This is the portion described in the process 1542.1. That is, the vase value recorded location BVP_i is indicating one area in the qualified storage so that the encrypted base value E.BV[*]_j is read from the area in the qualified storage.

The configuration in the qualified storage 223 of FIG. 14, which is the state in which the encrypted base values, the cipher information, the differences, the base value pointers, and others are recorded, is the same as that of FIG. 12.

Here, as described above, when the base value and the individual information group are both disposed on the location designated by the host device, in comparison with the case of recording the base value and the individual information group in each different data-storage medium, the recovering process may be simplified so that contradiction of data does not arise when the writing process results in a failure.

With the two embodiments described above, with such an internal configuration of the storage device, the host device is able to perform the writing process similarly to any other storage devices without changing the write destination of the usage control information, and a process, such as, encryption associated with the writing process; and, thus, the host device is able to implement a reduction of the information writing processing time in the storage device. A similar reduction of the processing time may also be obtained in the reading process.

Two examples of embodiments of the present invention have been described above; but, embodiments of the present invention are surely not restricted to such examples, as numerous other modifications and variations are within the spirit and scope of embodiments of the present invention.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A content recorder/player, comprising:
a first data-storage medium comprising a first data-storage area;
a second data-storage medium comprising a second data-storage area; and
a control section, said control section configured:
to encrypt, when any of a plurality of information groups each correlated with content data has a predetermined relationship with another in terms of a portion of information, said information groups having said predetermined relationship for writing into said first data-storage area;
to generate and to encrypt an individual information group from which said information having said predetermined relationship is omitted, and to perform writing thereof into said second data-storage area together with information about a recording-destination location to said first data-storage area;
to read and to decrypt said individual information group and an information group as a result of said writing together with information about a recording-destination location to said first data-storage area, and from said information about said recording-destination location to said first data-storage area, to read and to decrypt an information group recorded on a first recording-destination location; and
to restore, from an information group read from said second data-storage area, and from an information group read from said first data-storage area, an information group correlated with said content data based on said predetermined relationship, and to transmit said restored information group to an external device.

2. The content recorder/player of claim 1, wherein, when a value of data in an item included in any one of said plurality of information groups shows no matching at all with a value in an item of each of said remaining information groups, said value of said item is written into said first data-storage medium after being encrypted, and said value of said item is temporarily stored in its own storage location.

3. The content recorder/player of claim 1, wherein said information having said predetermined relationship represents a variable varying with a predetermined rule;
wherein said control section is further configured to write a difference of said variable varying with said predetermined rule to an area on said second data-storage medium;
wherein said omitted information is read from said first data-storage medium based on information that is read, for specifying a location on said first data-storage medium, from an area on said second data-storage medium specified by information about a location designated by an external device; and
wherein said information group is restored based on said predetermined rule using said information read from said first data-storage medium, said information read from said area on said second data-storage medium, and said difference.

4. The content recorder/player of claim 1, wherein said first data-storage medium comprises a same data-storage medium as said second data-storage medium.

5. The content recorder/player of claim 1, wherein said first data-storage medium comprises a data-storage medium different from said second data-storage medium with different properties.

6. A content recorder/player, comprising:
a first data-storage medium for storage of content data;
a second data-storage medium for storage of an information group correlated with said content data; and
a control section configured to control said first and said second data-storage media, said control section configured:
to record a second information group having a predetermined relationship with a first information group in terms of a portion of information;
to write, onto an area on said second data-storage medium, together with information about a recording-destination location of any predetermined information in said first information group, an individual information group generated by omitting said information having said predetermined relationship; and
to play back said second information group;
to read and to decrypt said individual information group and said information group written together with said information about said recording-destination location, to read said information of said first information group having said predetermined relationship from said information about said recording-destination location, to restore said information group correlated with said content data from said information of said first information group and said individual information group, and to make a response of said restored information group to an external device.

7. The content recorder/player of claim 6, wherein said information having said predetermined relationship represents a variable varying with a predetermined rule;
wherein said control section is further configured:
to write a difference of said variable varying with said predetermined rule together with said individual information group; and
to play back said second information group, information having said predetermined relationship read from said first information group based on said information about said recording-destination location;
wherein said omitted information is restored from said read information and said difference; and
wherein, from said restored omitted information and said read individual information group, said second information group is restored based on said predetermined rule.

8. The content recorder/player of claim 6, wherein said first data-storage medium comprises a same data-storage medium as said second data-storage medium.

9. A content writing and reading method, comprising:
encrypting, when any of a plurality of information groups each correlated with content data has a predetermined relationship with another in terms of a portion of information, information groups having said predetermined relationship for writing into a first data-storage area;
generating and encrypting an individual information group from which said information having said predetermined relationship is omitted, and writing thereof into a second data-storage area together with information about a recording-destination location to said first data-storage area;
reading and decrypting said individual information group and an information group as a result of said writing together with said information about said recording-destination location to said first data-storage area, and from said information about said recording-destination location to said first data-storage area, reading and decrypting an information group recorded on a first recording-destination location; and
restoring, from said information group read from said second data-storage area, and from said information group read from said first data-storage area, an information group correlated with said content data based on said predetermined relationship, and reading a content.

10. The content writing and reading method of claim 9, wherein when a value of data in an item included in any one of said plurality of information groups shows no matching at all with a value in an item of each of said remaining information groups, said value of said item is written into said first data-storage medium after being encrypted, and said value of said item is temporarily stored in its own storage location.
